(19) United States
(12) Patent Application Publication
(10) Pub. No.: US 2023/0281685 A1
(43) Pub. Date: Sep. 7, 2023

(54) INFORMATION PROCESSING APPARATUS, INFORMATION PROCESSING METHOD, PRINTING SYSTEM, AND STORAGE MEDIUM

(71) Applicant: CANON KABUSHIKI KAISHA, Tokyo (JP)

(72) Inventor: Hideyuki Kanamori, Kanagawa (JP)

(21) Appl. No.: 18/095,624

(22) Filed: Jan. 11, 2023

(30) Foreign Application Priority Data
Jan. 31, 2022 (JP) 2022-012948

(51) Int. Cl. G06Q 30/0601; H04N 1/44; G06Q 30/0207

(52) U.S. Cl. CPC G06Q 30/0603; G06Q 30/0222; H04N 1/4406

(57) ABSTRACT

Provided is a technique allows for execution of convenient processing to make a notification to a terminal device. Terminal information that is information related to each of terminal devices of users sharing a consumable, remaining amount information related to a remaining amount of the consumable, purchase authority information that is information related to purchase authority of the consumable, and notification information including notification conditions and information related to purchase of the consumable that is set according to the notification conditions are obtained. Additionally, the information related to purchase of the consumable is determined based on the terminal information, the remaining amount information, the purchase authority information, and the notification information.

### BACKGROUND

### Field

The present disclosure relates to an information processing apparatus, an information processing method, a printing system, and a storage medium that make a notification in accordance with a remaining amount of a consumable.

### Description of the Related Art

There has been known a printing system that allows for execution of printing by a printer managed by a server by using a terminal device. For example, the server obtains information on a consumable of the printer and, in accordance with the information, notifies the terminal of a message prompting purchase of the consumable and information on purchase of ink including discount information that is usable in a case of consumable purchase and the like. Note that, purchase of ink is executed from the terminal device having the authority. For this reason, it is desired for the above-described discount information out of the information on the purchase of ink to be transmitted to only the terminal device having the authority of ink purchase.

Japanese Patent Laid-Open No. 2003-167900 discloses a technique that allows for notification to a terminal device of information such as weather and the like of the surrounding area based on position information obtained by a server from the terminal device.

However, Japanese Patent Laid-Open No. 2003-167900 is merely a technique of making a notification based on the position information, and it is impossible to notify terminal devices held by multiple users sharing a printer and the like of information on purchase of ink in accordance with the authority of consumable purchase.

### SUMMARY

The present disclosure is made in view of the above-described problem and executes convenient notification processing to a terminal device.

In the first aspect of the present invention, there is provided an information processing apparatus configured to make a notification in each of terminal devices of users sharing a consumable, including:
a first obtainment unit configured to obtain terminal information that is information related to the terminal device including information related to the user;
a second obtainment unit configured to obtain remaining amount information that is information related to a remaining amount of the consumable;
a third obtainment unit configured to obtain purchase authority information that is information related to purchase authority of the consumable;
a fourth obtainment unit configured to obtain notification information including notification conditions and information related to purchase of the consumable that is set according to the notification conditions; and
a determination unit configured to determine the information related to purchase of the consumable based on the terminal information, the remaining amount information, the purchase authority information, and the notification information.

In the second aspect of the present invention, there is provided an information processing method of an information processing apparatus configured to make a notification in each of terminal devices of users sharing a consumable, including:
obtaining terminal information that is information related to the terminal device including information related to the user;
obtaining remaining amount information that is information related to a remaining amount of the consumable;
obtaining purchase authority information that is information related to purchase authority of the consumable;
obtaining notification information including notification conditions and information related to purchase of the consumable that is set according to the notification conditions; and
determining the information related to purchase of the consumable based on the terminal information, the remaining amount information, the purchase authority information, and the notification information.

In the third aspect of the present invention, there is provided a printing system, including:
a printer configured to perform printing on a printing medium;
a terminal device capable of displaying notified information and also executing printing by the printer; and
a server configured to manage a notification to the terminal device, wherein
the server includes
   a first obtainment unit configured to obtain terminal information that is information related to the terminal device including information related to a user holding the terminal device,
   a second obtainment unit configured to obtain remaining amount information that is information related to a remaining amount of a consumable of the printer,
   a third obtainment unit configured to obtain purchase authority information that is information related to purchase authority of the consumable,
   a fourth obtainment unit configured to obtain notification information including notification conditions and information related to purchase of the consumable that is set according to the notification conditions, and
   a determination unit configured to determine the information related to purchase of the consumable based on the terminal information, the remaining amount information, the purchase authority information, and the notification information.

In the fourth aspect of the present invention, there is provided a printing system, including:
a printer configured to perform printing on a printing medium;
a terminal device capable of displaying notified information and also executing printing by the printer; and
a server configured to manage a notification to the terminal device, wherein
the terminal device includes
   a first obtainment unit configured to obtain terminal information that is information related to the terminal device including information related to a user holding the terminal device,
   a second obtainment unit configured to obtain remaining amount information that is information related to a remaining amount of a consumable of the printer,
   a third obtainment unit configured to obtain purchase authority information that is information related to purchase authority of the consumable,
   a fourth obtainment unit configured to obtain notification information including notification conditions and information related to purchase of the consumable that is set according to the notification conditions, and
   a determination unit configured to determine the information related to purchase of the consumable based on the terminal information, the remaining amount information, the purchase authority information, and the notification information.

In the fifth aspect of the present invention, there is provided a non-transitory computer readable storage medium storing a program for causing a computer to function as an information processing apparatus, the information processing apparatus making a notification in each of terminal devices of users sharing a consumable, the information processing apparatus including:
a first obtainment unit configured to obtain terminal information that is information related to the terminal device including information related to the user;
a second obtainment unit configured to obtain remaining amount information that is information related to a remaining amount of the consumable;
a third obtainment unit configured to obtain purchase authority information that is information related to purchase authority of the consumable;
a fourth obtainment unit configured to obtain notification information including notification conditions and information related to purchase of the consumable that is set according to the notification conditions; and
a determination unit configured to determine the information related to purchase of the consumable based on the terminal information, the remaining amount information, the purchase authority information, and the notification information.

According to the present disclosure, it is possible to execute convenient notification processing to a terminal device.

Further features of the present disclosure will become apparent from the following description of exemplary embodiments with reference to the attached drawings.

### BRIEF DESCRIPTION OF THE DRAWINGS

FIG. 1 is a schematic configuration diagram of a printing system;

FIGS. 2A and 2B are diagrams illustrating a hardware configuration of a control system of each device forming the printing system;

FIG. 3 is a sequence diagram of notification processing in a first embodiment;

FIGS. 4A to 4C are diagrams illustrating examples of printing information, user information, and ink purchase information;

FIG. 5 is a diagram illustrating an example of notification setting;

FIG. 6 is a diagram illustrating a notification setting screen;

FIGS. 7A and 7B are diagrams illustrating an ink information screen;

FIG. 8 is a diagram illustrating the ink information screen on which an ink order region is displayed;

FIG. 9 is a flowchart illustrating a processing routine of determination processing;

FIGS. 10A and 10B are flowcharts illustrating processing routines of processing that is a subroutine of the determination processing;

FIGS. 11A and 11B are flowcharts illustrating processing routines of processing that is a subroutine of the determination processing;

FIG. 12 is a sequence diagram of notification processing in a case of printing-execution in a second embodiment;

FIG. 13 is a flowchart illustrating a processing routine of notification processing executed by a terminal;

FIG. 14 is a flowchart illustrating a processing routine of notification execution processing that is a subroutine of the notification processing;

FIG. 15 is a sequence diagram of notification processing in a case of no-printing-execution in the second embodiment;

FIG. 16 is a flowchart illustrating a processing routine of the notification processing executed by the terminal;

FIG. 17 is a sequence diagram of notification processing in a case of printing-execution in a third embodiment;

FIG. 18 is a flowchart illustrating a processing routine of the notification processing executed by the terminal;

FIG. 19 is a sequence diagram of notification processing in a case of no-printing-execution in the third embodiment;

FIG. 20 is a flowchart illustrating a processing routine of notification processing executed by the terminal; and

FIG. 21 is a diagram illustrating an example of notification setting in another embodiment.

### DESCRIPTION OF THE EMBODIMENTS

An example of embodiments of an information processing apparatus, an information processing method, a printing system, and a storage medium is described below in details with reference to the appended drawings. Note that, the following embodiments do not limit the present disclosure, and not all the combinations of the characteristics described in the present embodiments are necessarily required for the means for solving the problems of the present disclosure. Additionally, positions, shapes, and the like of the constituents described in the embodiments are merely examples and are not intended to limit the scope of this disclosure.

### First Embodiment

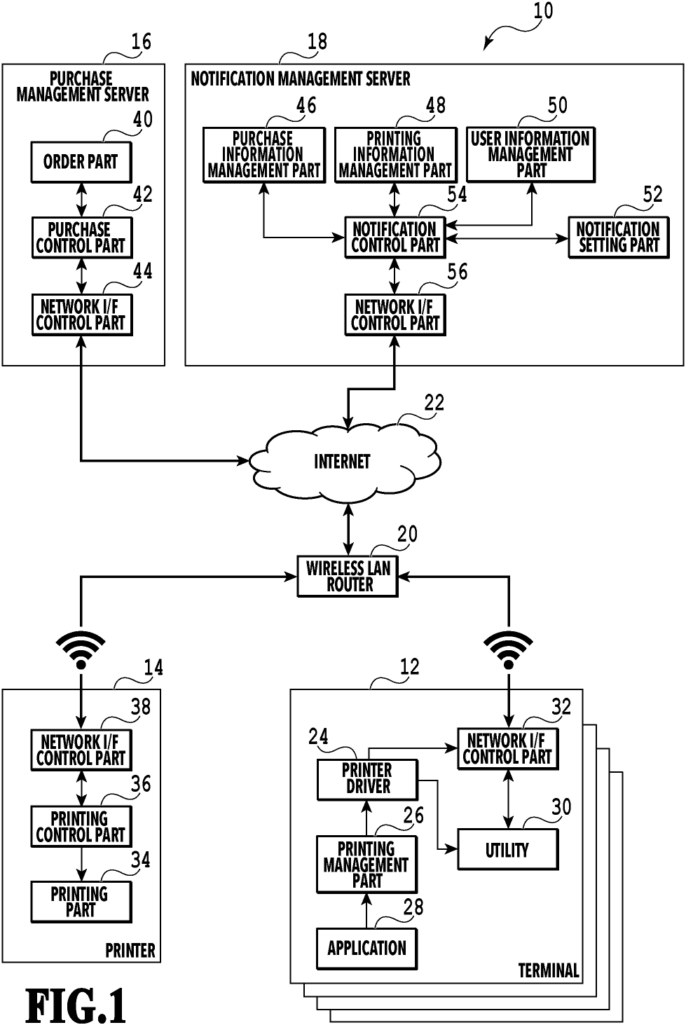

A printing system including an information processing apparatus in a first embodiment is described with reference to FIGS. 1 to 11B.

### <Printing System>

FIG. 1 is a schematic configuration diagram of the printing system including the information processing apparatus in the first embodiment. A printing system 10 in FIG. 1 includes multiple terminal devices 12 held by users who receive a service in the printing system 10 and a printer 14 that performs printing based on an instruction from each terminal device 12. Additionally, the printing system 10 includes a purchase management server 16 that manages purchase of a consumable and a notification management server 18 that manages notification to the terminal device 12. Note that, in the following descriptions, a “terminal device” is simply referred to as a “terminal” as needed.

The terminal 12 and the printer 14 are connected to a wireless local area network (LAN) router 20 through wireless communication and have a configuration to be communicable to each other. The wireless LAN router 20 is connected to the Internet 22, and the Internet 22 is connected to the purchase management server 16 and the notification management server 18. Accordingly, each of the terminal 12 and the printer 14 has a configuration to be communicable with the purchase management server 16 and the notification management server 18 through the wireless LAN router 20 and the Internet 22.

In the present embodiment, each of the multiple users is able to perform printing by the printer 14 by using the terminal 12 and purchase ink, which is a consumable of the printer 14, through the purchase management server 16. Thus, in the printing system 10, the multiple users share the printer 14. Additionally, in the present embodiment, in accordance with an ink remaining amount in the printer 14, the notification management server 18 makes a notification of the ink remaining amount, ink discount information that is usable for ink purchase, and the like.

### <Terminal Device>

The terminal 12 includes a printer driver 24, a printing management part 26, an application 28, a utility 30, and a network interface (I/F) control part 32. In the terminal 12, once the user requests printing of image data created by the application 28, the request is inputted to the printing management part 26 as a printing job. The printing management part 26 then transmits the inputted printing job to the printer driver 24.

Once receiving the printing job, the printer driver 24 generates printing data that the printer 14 is construable and transmits the generated printing data to the printer 14 through the network I/F control part 32. Additionally, once transmitting the printing data to the printer 14, the printer driver 24 notifies the utility 30 of that printing is executed.

The utility 30 is software that provides a function to display various pieces of information such as an ink remaining amount in the printer 14, ink discount information usable in a case of ink purchase, and the like on a display 210 (described later) and also a function to purchase ink. Once being notified of execution of printing from the printer driver 24, the utility 30 transmits as printing information that printing is executed by the printer 14 to the notification management server 18 through the network I/F control part 32. Additionally, through the network I/F control part 32, the utility 30 displays the ink discount information notified from the notification management server 18 on the display 210 and transmits information on purchase (order) of ink to the purchase management server 16.

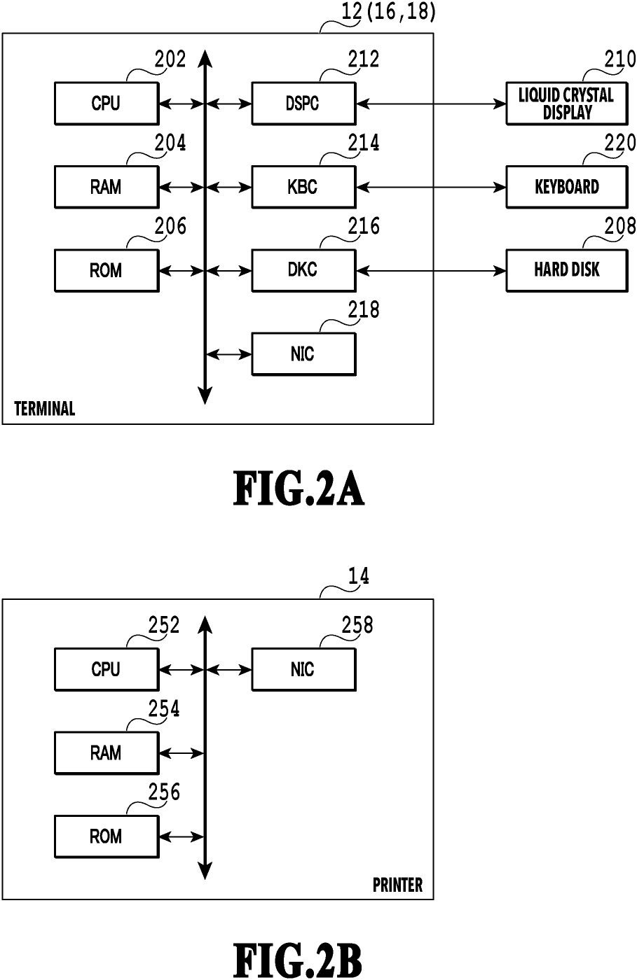

Next, a hardware configuration of the terminal 12 is described. FIG. 2A is a diagram illustrating a hardware configuration of a control system of the terminal 12. In the terminal 12, an operating system (OS) is incorporated, and the constituents of the terminal 12 are managed by the OS. The terminal 12 has a hardware configuration that a general information processing apparatus has.

Specifically, the terminal 12 includes a central processing unit (CPU) 202, a RAM 204, and a ROM 206. The CPU 202 executes a program such as an OS and an application that is stored in a ROM for programs of the ROM 206 or loaded into the RAM 204 from a hard disk 208. Various types of processing illustrated by using the later-described flowcharts are executed by the programs stored in the ROM 206. The RAM 204 also functions as a main memory, a working area, and the like of the CPU 202.

Additionally, the terminal 12 includes a display controller (DSPC) 212 that controls display on the display 210 and a keyboard controller (KBC) 214 that controls input data from a keyboard 220. Moreover, the terminal 12 includes a disk controller (DKC) 216 that controls data access in the hard disk 208 storing various data. Furthermore, the terminal 12 includes a network interface card (NIC) 218 that controls exchanging of signals through a network. In the present embodiment, the configuration allows for displaying of the later-described various notification contents on the display 210 of the terminal 12.

### <Printer>

The printer 14 includes a printing part 34 that performs printing by ejecting ink on a printing medium, a printing control part 36 that controls printing by the printing part 34, and a network I/F control part 38 that controls transmission and reception of information in the printer 14. Once receiving the printing data from the terminal 12 through the network I/F control part 38, the printing control part 36 performs printing by controlling the printing part 34 based on the printing data.

Next, a hardware configuration of the printer 14 is described. FIG. 2B is a diagram illustrating a hardware configuration of a control system of the printer 14. The printer 14 includes a CPU 252, a RAM 254, and a ROM 256. The RAM 254 functions as a working area of the CPU 252. The CPU 252 loads a program stored in the ROM 256 to the RAM 254 and executes the program. Additionally, the printer 14 includes an NIC 258 that controls conversion of a signal through the network.

### <Purchase Management Server>

The purchase management server 16 includes an order part 40 that orders ink, a purchase control part 42 that causes the order part 40 to execute ordering of ink, and a network I/F control part 44 that controls transmission and reception of information in the purchase management server 16. The order part 40 orders ink an external order acceptance device that accepts the order of ink based on information outputted from the purchase control part 42.

Once receiving information on purchase of ink from the terminal 12 through the network I/F control part 44, the purchase control part 42 outputs information for ordering ink to the order part 40 based on the purchase information. Additionally, through the network I/F control part 44, the purchase control part 42 transmits ink purchase information including information on the terminal 12 that orders ink and information on the printer 14 used to the notification management server 18. A hardware configuration of the purchase management server 16 is basically the same as that of the terminal 12; for this reason, detailed descriptions thereof are omitted.

### <Notification Management Server>

The notification management server 18 includes a purchase information management part 46 that manages information such as the ink purchase information, a printing information management part 48 that manages the printing information, and a user information management part 50 that manages user information including information on the user who uses the printer 14 and the terminal 12 of the user. Additionally, the notification management server 18 includes a notification setting part 52 that accepts various types of setting for notification and a notification control part 54 that controls an output destination of information received through a network I/F control part 56. Additionally, the notification management server 18 includes the network I/F control part 56 that controls transmission and reception of information in the notification management server 18.

Once receiving the ink purchase information from the purchase management server 16 through the network I/F control part 56, the notification control part 54 stores the received ink purchase information into the purchase information management part 46. The ink purchase information is, for example, purchase authority information that is information on whether there is the authority of ink purchase, which includes information on the user having the authority of ink purchase and information on the terminal with which ink is purchased. In the present embodiment, the ink purchase information is information that allows for identification of the terminal 12, the user, and the printer 14 that purchase ink.

Additionally, once receiving the printing information from the terminal 12 through the network I/F control part 56, the notification control part 54 stores the received printing information into the printing information management part 48. The printing information is, for example, information that allows for identification of the fact that printing is executed by the printer 14 and the terminal 12 and the printer 14 that execute the printing. Moreover, the notification control part 54 generates the user information based on information managed by the purchase information management part 46 and the printing information management part 48 and stores the generated user information in the user information management part 50. The user information is, for example, information on the user who uses the printer 14, which includes information on the terminal used by each user.

The notification setting part 52 combines various conditions to perform setting of the notification contents and a notification timing to the terminal 12 as a notification target and also holds a notification setting generated by the setting. Note that, in the present embodiment, the notification contents are information on purchase of ink. Specifically, the notification contents are information on discount of ink (ink discount information) and information prompting request of ink purchase (later-described ink-purchase-required request information). The setting by the notification setting part 52 is executed by a service provider providing a printing service by the printing system 10. Specific setting by the notification setting part 52 is described later. Additionally, the notification control part 54 notifies the terminal 12 of the ink discount information and the like based on the notification setting of the notification setting part 52 and the information held in the purchase information management part 46, the printing information management part 48, and the user information management part 50. A hardware configuration of the notification management server 18 is basically the same as that of the terminal 12; for this reason, detailed descriptions thereof are omitted.

### <Notification Processing in Printing System>

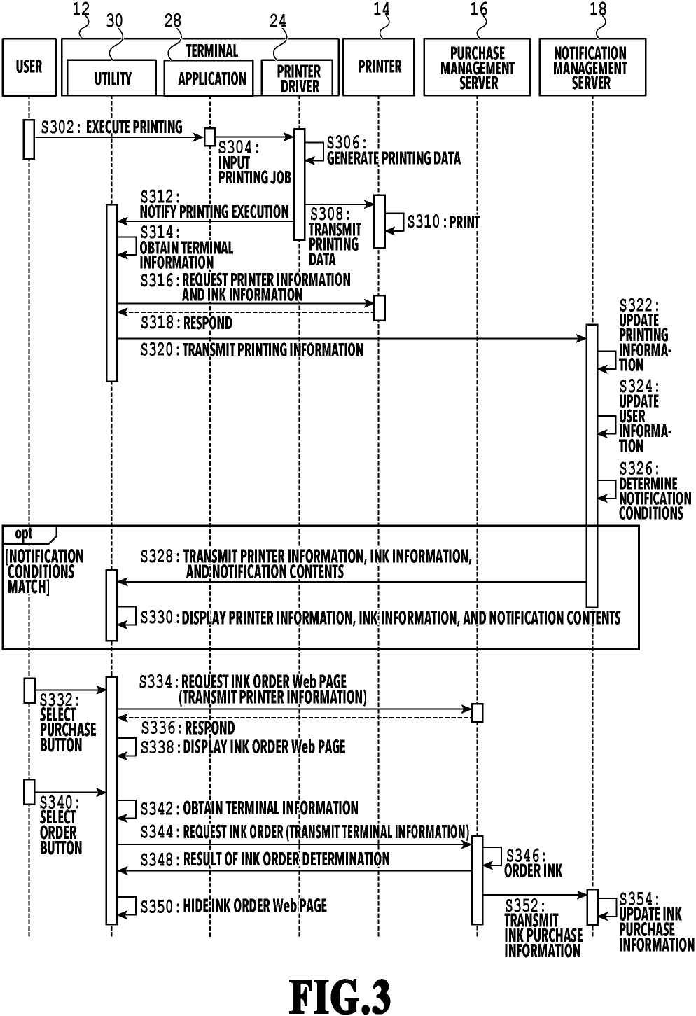

In the above-described configuration, once the user requests printing in the terminal 12, that is, gives instruction to execute printing, in the printing system 10, printing based on the request is performed in the printer 14, and a notification in accordance with the state of the printer 14 is made in the terminal 12 as needed. FIG. 3 is a diagram illustrating a processing sequence of notification processing in the printing system 10 in the present embodiment.

Once the user requests printing of the data created by the application 28 (S302), the application 28 generates the printing job based on the request and outputs the generated printing job to the printer driver 24 through the printing management part 26 (S304). Next, the printer driver 24 generates the printing data that the printer 14 is construable based on the printing job (S306) and transmits the generated printing data to the printer 14 through the network I/F control part 32 (S308). Thus, in the present embodiment, the printer 14 has a configuration that allows for execution of printing in accordance with a request from the terminal 12.

Once receiving the printing data, the printer 14 executes printing on the printing medium (S310). Additionally, after transmitting the printing data to the printer 14, the printer driver 24 notifies the utility 30 of that printing is executed (S312). The utility 30 obtains the user ID and the serial number of the terminal in which the utility 30 operates (hereinafter, referred to as a “self-terminal” as needed) as terminal information on the self-terminal (S314). Note that, in the printing system 10, the user ID and the serial number of the terminal 12 used by the user in the printing system 10 are registered. Accordingly, in S314, the utility 30 obtains the user ID and the serial number of the self-terminal that are registered in advance. Note that, the terminal information is held in a storage region such as the ROM 206 of each terminal 12.

Thereafter, the utility 30 requests the printer 14 to provide the model name and the serial number of the printer 14 as printer information on the printer that executes printing and the ink information indicating a remaining amount level of the ink mounted in the printer 14 (S316). Then, the response from the printer 14 to the request is obtained (S318). In S318, for example, the printer 14 transmits the printer information and the ink information to the terminal 12 in a timing in which printing ends. That is, the ink information transmitted to the utility 30 in and after S318 reflects a remaining amount of the ink after the printing based on the printing data. Thereafter, as the printing information, the utility 30 transmits the terminal information on the terminal that requests execution of printing (obtained in S314) and the printer information on the printer that executes printing (the printer information and the ink information obtained in S318) to the notification management server 18 (S320).

Once receiving the printing information, the notification management server 18 updates the information in the printing information management part 48 (S322), and if the terminal information included in the printing information is not included in the user information managed by the user information management part 50, the notification management server 18 updates the information in the user information management part 50 (S324). Note that, in S324, if the terminal information included in the printing information is included in the user information managed by the user information management part 50, the processing proceeds to S326 described later without updating the information in the user information management part 50.

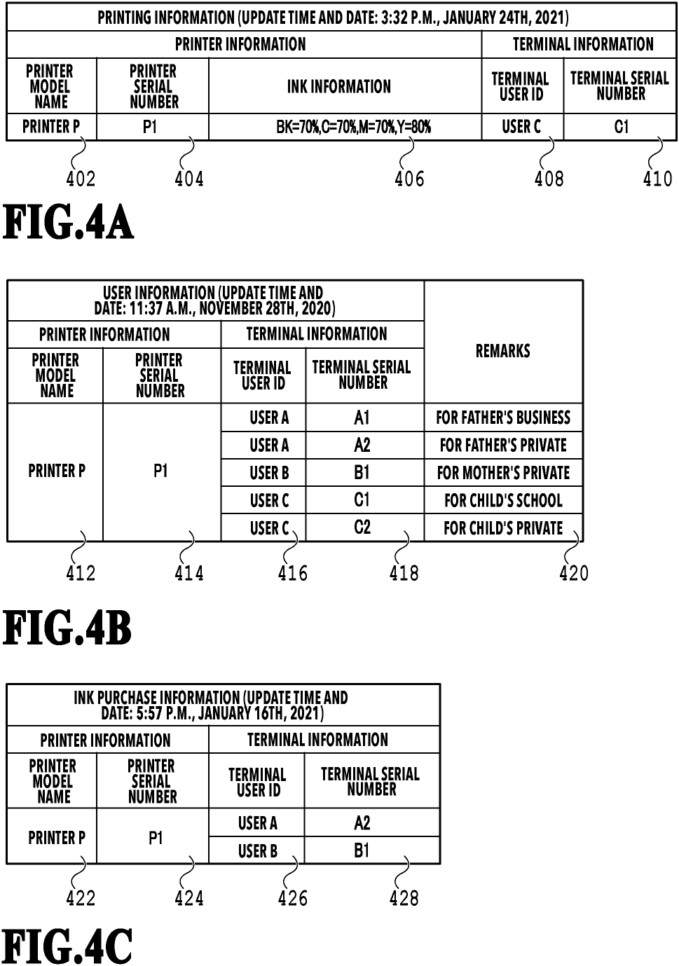

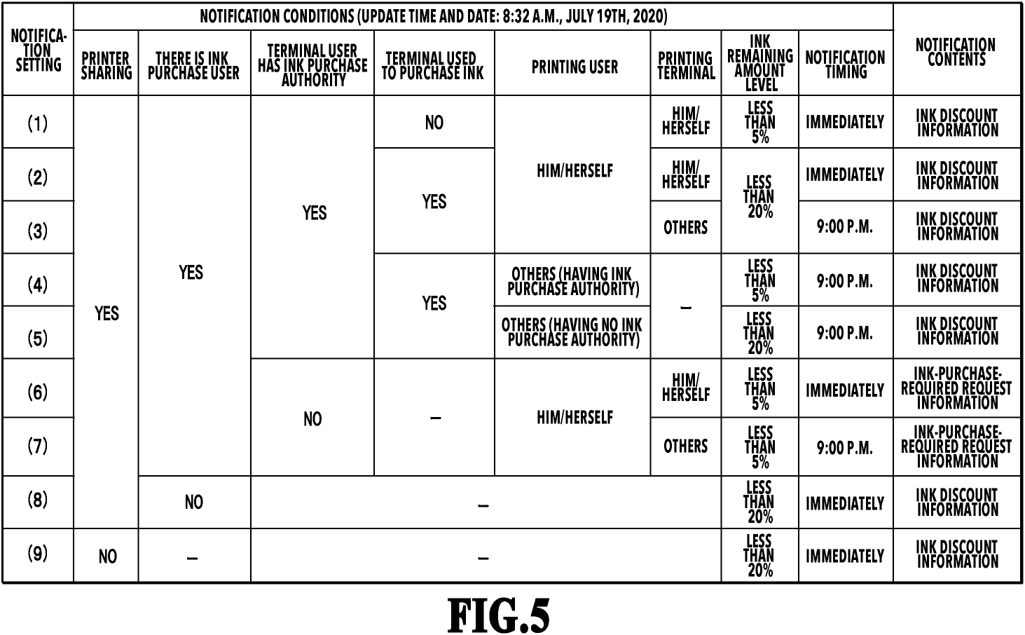

Here is described the printing information, the user information, and the ink purchase information managed by the notification management server 18 with reference to FIGS. 4A to 4C. FIG. 4A is a diagram illustrating an example of information included in the printing information, FIG. 4B is a diagram illustrating an example of information included in the user information, and FIG. 4C is a diagram illustrating an example of information included in the ink purchase information.

In the notification management server 18, the printing information, the user information, and the ink purchase information are each associated with information on update time and date on which the information is updated last time in the management parts managing the corresponding information (the purchase information management part 46, the printing information management part 48, and the user information management part 50). Note that, in the present embodiment, the information on the update time and date may not be associated with each information.

Additionally, in the notification management server 18, the following five pieces of information are held in the printing information management part 48 as the printing information after printing by the printer 14. That is, the five pieces of information are a model name 402 of the printer 14 that performs printing, a serial number 404 of the printer 14, ink information 406 on the printer 14, a user ID 408 of the terminal 12 that requests printing, and a serial number 410 of the terminal 12. In the present embodiment, four colors of ink which are black (BK), cyan (C), magenta (M), and yellow (Y) are mounted in the printer 14, and the ink information that is the remaining amount information on the ink holds a value indicating an ink remaining amount level of each ink at the end of printing. Note that, in the present embodiment, a case where the ink remaining amount level is less than 5% is a notification state in which an alert prompting purchase and replacement of ink and the like is notified.

Moreover, in the notification management server 18, the following five pieces of information are held in the user information management part 50 as the user information on the users who share the printer 14. That is, the five pieces of information are a model name 412 of the printer 14 capable of printing, a serial number 414 of the printer 14, user IDs 416 of the terminals 12 associated with the printer 14, serial numbers 418 of the terminals 12, and remark information 420 associated with each of the terminals 12. Note that, the remark information 420 may not be included in the user information. In FIG. 4B, an example where three users A to C share the printer 14 in home is illustrated. Specifically, the user A who is a father uses a terminal A1 for business and a terminal A2 for private, the user B who is a mother uses a terminal B1 for private, and the user C who is a child uses a terminal C1 for school and a terminal C2 for private. Accordingly, in S324, if the user ID 408 and the serial number 410 of the terminal 12 that are the terminal information included in the printing information are not included in the terminal information in the user information, the terminal information included in the printing information is added to the terminal information in the user information.

Furthermore, in the notification management server 18, the following four pieces of information are held in the purchase information management part 46 as the ink purchase information of the user who purchases the ink of the printer 14. That is, a model name 422 of the printer 14 for which the ink is purchased, a serial number 424 of the printer 14, user IDs 426 of the terminals 12 used to purchase the ink, and serial numbers 428 of the terminals 12. In FIG. 4C, the user A who is a father and the user B who is a mother are able to use the owning terminals 12 to purchase ink. Specifically, the user A who is a father is able to use the terminal A2 for private to purchase ink, and the user B who is a mother is able to use the terminal B1 for private to purchase ink.

Note that, in the ink purchase information, for example, once ink is purchased through a website for ink purchase by using the terminal 12 that is not registered on the ink purchase information, the terminal information on the terminal 12 is newly added and registered on the ink purchase information in the purchase management server 16. Additionally, the terminal 12 usable for purchase of ink may be registered in a case of registration of the user who uses the printing system 10. In the following descriptions, the terminal 12 identified by the terminal information registered on the ink purchase information is described as the terminal 12 that was used to purchase ink and the terminal 12 usable to purchase ink.

Referring back to FIG. 3. Thereafter, the notification management server 18 determines the notification contents to be notified to the terminals 12 of the users sharing the printer 14 (S326). Note that, in the present specification, “the terminals 12 of the users sharing the printer 14” is also referred to as “the terminals 12 sharing the printer 14”. In S326, the notification contents (information on purchase of ink) according to the notification conditions set by the notification setting are determined for each terminal 12. Note that, in the notification conditions of the notification setting, a notification timing that is a timing for making a notification in the terminal 12 is set; details are described later. Accordingly, in S326, the notification timing that is set as the notification conditions under the setting conditions corresponding to the determined notification contents is also obtained.

Additionally, the notification management server 18 transmits the print information, the ink information, the determined notification contents, and the like to the terminals 12 sharing the printer 14 (S328). In S328, the determined notification contents are transmitted to the terminal 12 from the notification management server 18 based on the notification timing obtained in S326. That is, in a case where the notification timing is “immediately”, for example, the notification management server 18 transmits immediately the notification contents to the terminal 12 once the notification contents is determined in S326. On the other hand, in a case where the notification timing is, for example, “9:00 P.M.”, after the notification contents is determined in S326, the notification management server 18 transmits the notification contents in a timing of 9:00 P.M. to the terminal 12. Note that, the notification management server 18 includes a clock.

Thus, in the present embodiment, once receiving the printing information and the printer information from the utility 30, the notification management server 18 makes a notification in accordance with execution of printing by the user by determining and transmitting the notification contents in accordance with the notification conditions of the notification setting of each terminal 12. Note that, for example, the notification management server 18 may accumulate the printing information received from the utility 30 and determine and transmit the notification contents in a specific timing. The specific timing may be, for example, a timing in which the service provider operates the notification management server 18, a periodic timing such as once a day, and the like. With this, it is possible to reduce the processing load of the notification management server 18.

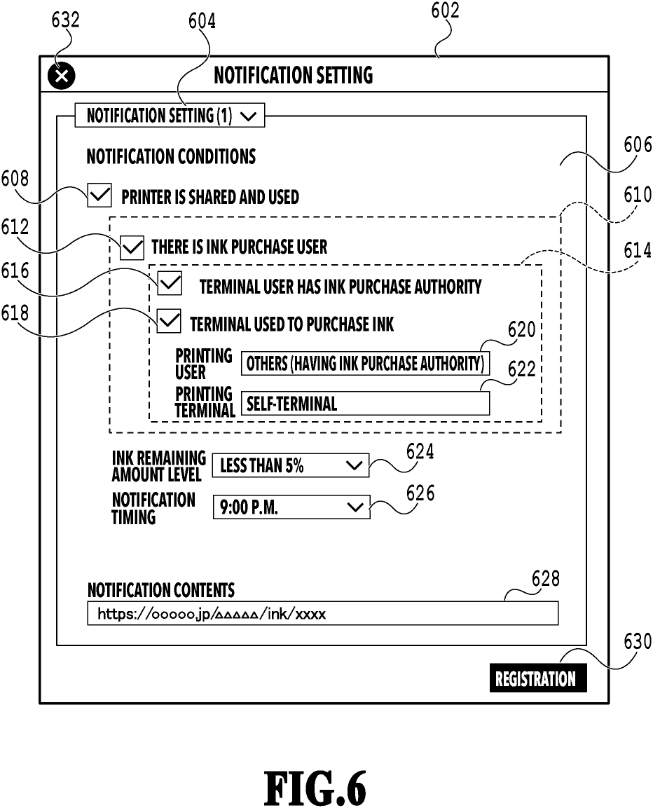

Here are described the notification conditions of the notification setting and setting of the notification conditions with reference to FIGS. 5 and 6. FIG. 5 is a diagram illustrating an example of the notification setting. FIG. 6 is a diagram illustrating a notification setting screen for setting of the notification conditions. In the present embodiment, the notification contents are set respectively for nine notification settings under different notification conditions. The notification conditions are whether the printer 14 is shared, whether there is an ink purchase user, whether the terminal user has the ink purchase authority, whether the terminal is used for ink purchase, whether the user is a printing user, whether the terminal is a printing terminal, and the ink remaining amount level. Additionally, as the notification conditions, the notification timing is set. Note that, the contents of the notification conditions, combination of the notification conditions, the notification contents, and the like illustrated in FIG. 5 are merely examples and are not limited to the illustration in FIG. 5.

The notification management server 18 stores the notification setting and the information on the update time and date of the notification setting in the notification setting part 52. Note that, in the present embodiment, the information on the update time and date may not be associated with the notification setting. Between notification settings (1) and (2), in a case where the user who executes printing has the ink purchase authority, a threshold of the ink remaining amount level, which is for notifying the terminal 12 that executes printing of the ink discount information, is changed depending on whether the terminal 12 that executes printing is the terminal used to order ink. Specifically, in the notification setting (1), the notification is made under the condition of less than 5%, which is less than a first threshold, and in the notification setting (2), the notification is made under the condition of less than 20%, which is less than a second threshold greater than the first threshold.

Additionally, between notification settings (2) and (3), the timing to make a notification to the user used for purchase of ink is changed depending on whether the terminal is the terminal 12 that executes printing. Moreover, in order to notify the terminals 12 of all the users having the ink purchase authority of the ink discount information once one user performs printing, corresponding notification settings are associated with “ink discount information” as the notification contents (see notification settings (1) to (5)). Note that, between notification settings (4) and (5), the threshold of the ink remaining amount level, which is for notifying of the ink discount information, is changed depending on whether another user who executes printing has the ink purchase authority. Note that, whether the user has the authority of ink purchase is whether the user holds the terminal 12 usable for ink purchase.

If the user is a user having the ink purchase authority, it is possible to confirm the ink discount information notified to the own terminal once performing printing, and if necessary, it is possible to purchase ink by him/herself. Accordingly, in a case where another user having no ink purchase authority performs printing, the user is notified of the ink discount information once the ink remaining amount level becomes less than 20%. On the other hand, another user having the ink purchase authority is not notified of the ink discount information until the ink remaining amount level becomes less than 5%, which is an alert state. With this, excessive notification of the ink discount information to a user other than the user who requests printing is prevented.

Additionally, between notification settings (6) and (7), if the ink remaining amount level is less than 5%, which is the alert state, in a case where the user having no ink purchase authority performs printing, the ink-purchase-required request information is notified instead of the ink discount information. This ink-purchase-required request information is information prompting a request to the user having the authority of purchase to purchase ink. Moreover, in the notification settings (1) to (7), the notification by the notification management server 18 to the terminal 12 that executes printing is made immediately (see the notification settings (1), (2), and (6)). On the other hand, the notification to another terminal 12 is made at a set clock time instead of the immediate notification (see the notification settings (3), (4), (5), and (7)).

With this, it is possible make a notification of appropriate contents depending on whether the user has the ink purchase authority. Note that, in a notification setting (8), if no one of the users sharing the printer 14 has purchased ink, all the terminals 12 sharing the printer 14 are immediately notified of the ink discount information once one user executes printing by the printer. Additionally, in a notification setting (9), if the printer 14 is not shared with another user, the terminal that requests printing is immediately notified of the ink discount information once the user executes printing by the printer 14.

In such notification settings, the notification conditions and the notification contents thereof are set by the service provider. Specifically, the service provider can set the notification conditions in the notification setting by using a notification setting screen 602 displayed on the display 210 in the notification management server 18 (see FIG. 6). The notification setting screen 602 is displayed on the display 210 of the notification management server 18 by the notification setting part 52 based on input from the service provider.

The service provider can switch a setting region 606 by a “notification setting” pop-up menu 604 in the notification setting screen 602 and can edit and register the multiple notification settings. In the present embodiment, the notification settings (1) to (9) can be registered. It is possible to set as the notification conditions whether the printer 14 is shared by a “printer is shared” checkbox 608 in the setting region 606. If the “printer is shared” checkbox 608 is enabled, the notification setting part 52 allows for setting of a region 610, and if the “printer is shared” checkbox 608 is disabled, the notification setting part 52 grays out the region 610 and does not allow for the setting.

With an “there is ink purchase user” checkbox 612 in the region 610, it is possible to set as the notification conditions whether there is the user able to purchase ink out of the users sharing the printer 14. If the “there is ink purchase user” checkbox 612 is enabled, the notification setting part 52 allows for setting of a region 614, and if the “there is ink purchase user” checkbox 612 is disabled, the notification setting part 52 grays out the region 614 and does not allow for the setting.

With a “terminal user has ink purchase authority” checkbox 616 in the region 614, it is possible to set as the notification conditions whether the user who uses the terminal 12 has the ink purchase authority. With a “terminal used to purchase ink” checkbox 618 in the region 614, it is possible to set as the notification conditions whether the terminal is the terminal 12 used to purchase ink (able to purchase ink). With a “printing user” pop-up menu 620 in the region 614, it is possible to set as the notification conditions whether the user who executes printing is him/herself or another user. Additionally, in a case of another user, it is possible to set whether the user is another user having the ink purchase authority or another user having no ink purchase authority. With a “printing terminal” pop-up menu 622 in the region 614, it is possible to set as the notification conditions whether the terminal 12 that executes printing is the self-terminal.

With an “ink remaining amount level” pop-up menu 624 in the setting region 606, it is possible to set as the notification conditions the ink remaining amount level of the printer 14. For example, it is possible to set the ink remaining amount level as the threshold that is less than any ink remaining amount level from 0% to 100% in increments of 5%. With a “notification timing” pop-up menu 626 in the setting region 606, for example, it is possible to set as the timing of notification any time from 12:00 A.M. to 12:00 A.M. in increments of one hour or “immediately”. A “notification contents” setting field 628 in the setting region 606 can designate a path to the notification contents.

Once a “registration” button 630 is selected, the notification setting part 52 stores the notification conditions and the notification contents set in the setting region 606 into a storage region such as the RAM 204 and registers as the notification setting. Additionally, once a “× (close)” button 632 is selected, the notification setting screen 602 is closed.

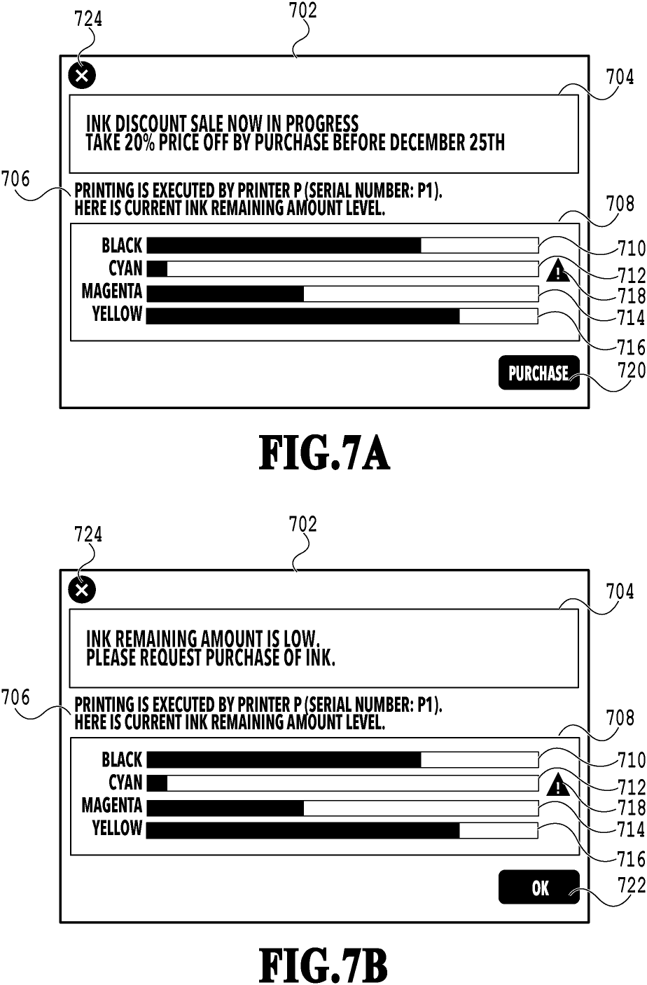

Referring back to FIG. 3. The utility 30 of the terminal 12 that receives the information transmitted from the notification management server 18 displays the ink information screen based on the received information (S330). In S330, in the terminal 12 of the user having the ink purchase authority, the ink information screen as illustrated in FIG. 7A is displayed. Additionally, in the terminal 12 of the user having no ink purchase authority, the ink information screen as illustrated in FIG. 7B is displayed. While FIGS. 7A and 7B are examples of the ink display screen, FIG. 7A is the ink information screen displayed on the terminal of the user having the ink purchase authority, and FIG. 7B is the ink information screen displayed on the terminal of the user having no ink purchase authority.

Specifically, in S330, processing as described below is performed on the terminal 12 of the user having the ink purchase authority. Note that, the ink discount information is transmitted as the notification contents from the notification management server 18 in S328 to the terminal 12 of the user having the ink purchase authority. The utility 30 displays the ink discount information out of the received information on a notification contents display part 704. In the notification contents display part 704, for example, a fact that ink is sold with a discount, a discount sell-by date, a discount rate, and the like are displayed as the ink discount information.

Additionally, based on the printer information out of the received information, the utility 30 displays on a printer information display part 706 that printing is executed by the printer 14. Moreover, based on the ink information out of the received information, the utility 30 displays on an ink remaining amount level display part 708 the ink remaining amount level of each ink in the printer 14. The ink remaining amount level display part 708 is provided with level display regions 710, 712, 714, and 716 corresponding to the inks of BK, C, M, and Y Accordingly, in S330, the remaining amount level of the ink corresponding to each level display region is displayed. Additionally, in the ink remaining amount level display part 708, if the ink remaining amount level is less than 5%, which is the alert state, an alert icon 718 is displayed. Then, in an ink information screen 702, a “purchase” button 720 is displayed.

On the other hand, in S330, processing as described below is performed on the terminal 12 of the user having no ink purchase authority. Note that, the ink-purchase-required request information is transmitted as the notification contents from the notification management server 18 in S328 to the terminal 12 of the user having no ink purchase authority. The utility 30 displays the ink-purchase-required request information out of the received information on the notification contents display part 704. In the notification contents display part 704, for example, a fact that the ink remaining amount is low, prompting of the request to purchase ink, and the like are notified as the ink-purchase-required request information. Additionally, as with the case of the terminal of the user having the ink purchase authority, the utility 30 displays that printing is executed by the printer 14 on the printer information display part 706 and the ink level remaining amount of each ink on the ink remaining amount level display part 708. Additionally, on this ink information screen 702, an “OK” button 722 is displayed instead of the “purchase” button 720.

Note that, once the “OK” button 722 and a “× (close)” button 724 are selected, the utility 30 closes the ink information screen 702, and the processing in FIG. 3 ends. Accordingly, in the following descriptions, processing in a case where an operation is performed in the ink information screen 702 displayed on the terminal 12 of the user having the ink purchase authority is described.

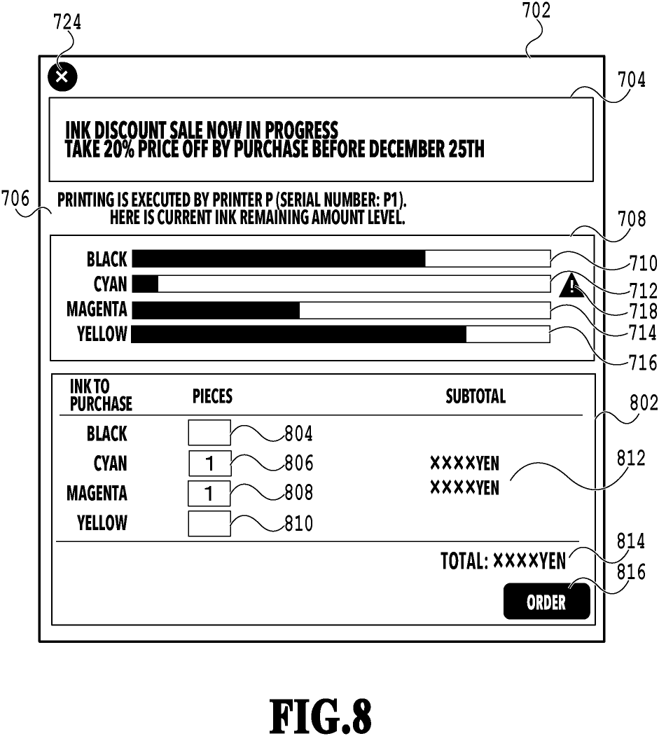

Referring back to FIG. 3. Next, once the “purchase” button 720 displayed on the ink information screen 702 is selected (S332), the utility 30 transmits the printer information to the purchase management server 16. Additionally, the utility 30 requests the purchase management server 16 to provide a webpage in which the ink for the printer 14 identified by the transmitted printer information can be purchased (S334) and obtains the response (S336). Thereafter, as illustrated in FIG. 8, the utility 30 generates an ink order region 802 in the ink information screen 702 and displays the webpage obtained from the purchase management server 16 on the ink order region 802 (S338).

FIG. 8 is a diagram illustrating the ink information screen 702 in which the ink order region 802 is generated. The utility 30 displays text fields 804, 806, 808, and 810 that allow for designation of the ordered number of the BK ink, the C ink, the M ink, and the Y ink used in the printer 14 in the ink order region 802. Additionally, in accordance with the ordered number inputted by the user to the text fields, the utility 30 displays a subtotal amount in a subtotal display region 812 and displays a total amount in a total display region 814. Moreover, an “order” button 816 is displayed in the ink order region 802.

Referring back to FIG. 3. Once the user selects the “order” button 816 displayed in the ink order region 802 (S340), the utility 30 obtains the user ID and the serial number of the self-terminal as the terminal information (S342). Thereafter, the utility 30 transmits the terminal information obtained in S342 and the order information inputted to the ink order region 802 to the purchase management server 16 (S344).

Once receiving the order information, the purchase management server 16 accepts various inputs such as address and payment method required for shipping of ink to order ink (S346) and transmits the determination result of the ink order to the terminal 12 identified by the received terminal information (S348). Note that, in the purchase management server 16, it is possible to use widely-known various techniques as the technique for reception of the order information to determination of the order; for this reason, detailed descriptions thereof are omitted.

Once receiving the determination result of the ink order by the terminal 12, the utility 30 hides the ink order region 802 (S350). The purchase management server 16 transmits the ink purchase information including the printer information on the printer 14 that uses the ordered ink and the terminal information on the terminal 12 that orders the ink to the notification management server 18 (S352). In S352, if necessary, the ink purchase information is updated, and the updated ink purchase information is transmitted to the notification management server 18. For example, in a case where ink is purchased by the terminal in which the terminal information includes no ink purchase information or the like, in the purchase management server 16, the terminal is added to the terminal information in the ink purchase information to update the ink purchase information. Once receiving the ink purchase information, the notification management server 18 updates the information managed by the purchase information management part 46 (S354).

### <Determination Processing>

Next, determination processing in the notification management server 18 to determine the notification contents that the notification control part 54 notifies each terminal 12 based on the notification setting saved in the notification setting part 52 is described. Accordingly, the notification control part 54 determines the notification contents according to the notification conditions set in the notification setting by obtaining the notification setting (notification information) from the notification setting part 52 and executing the determination processing. That is, in the present embodiment, the notification control part 54 functions as an obtainment unit that obtains the notification conditions for determining the notification contents together with the notification contents as the information on purchase of ink and also functions as a determination unit that determines the notification contents.

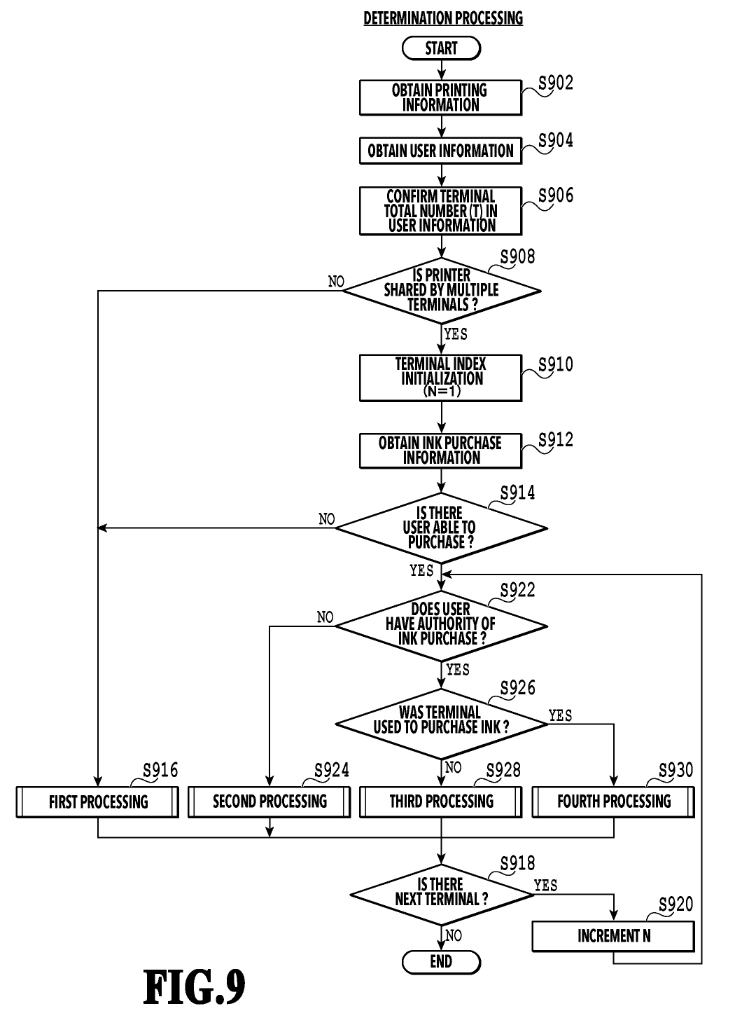

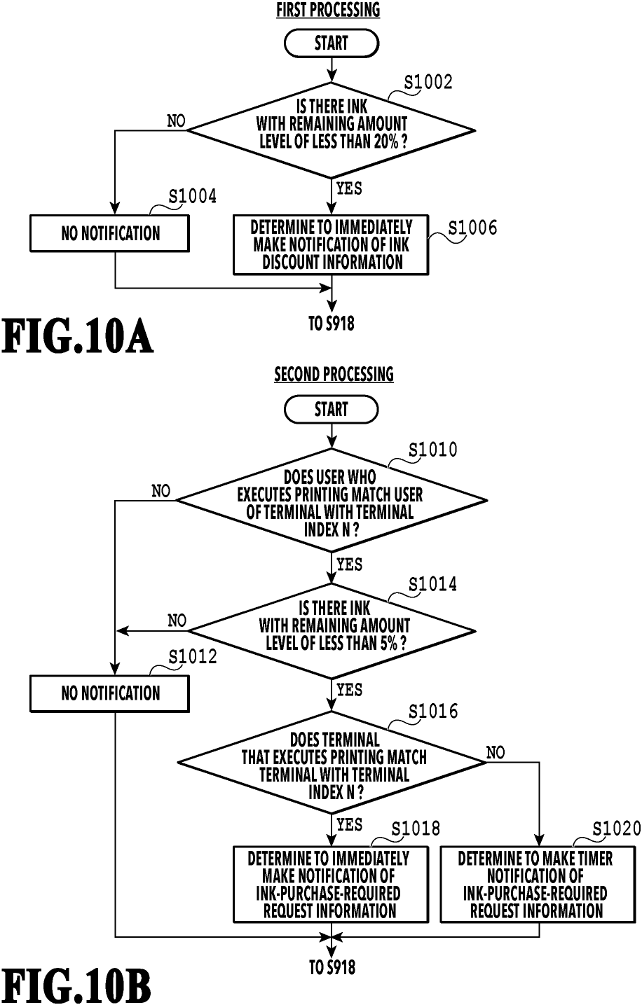

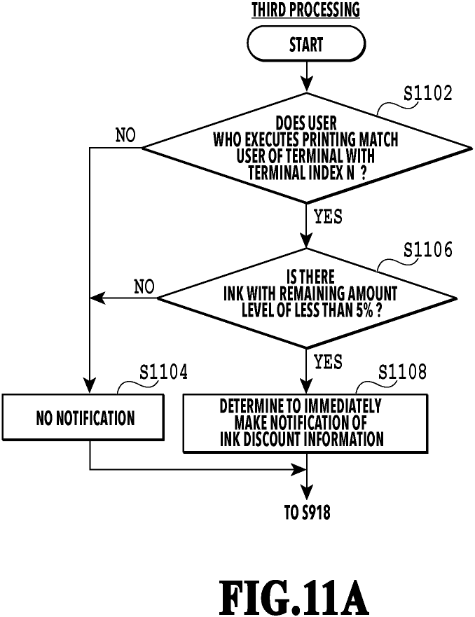

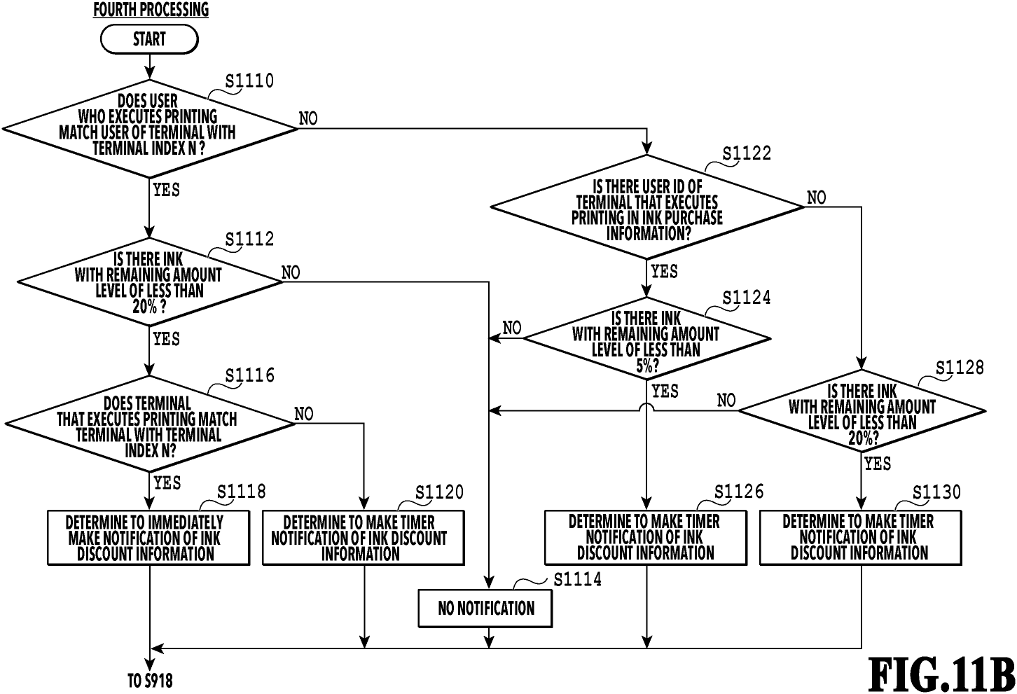

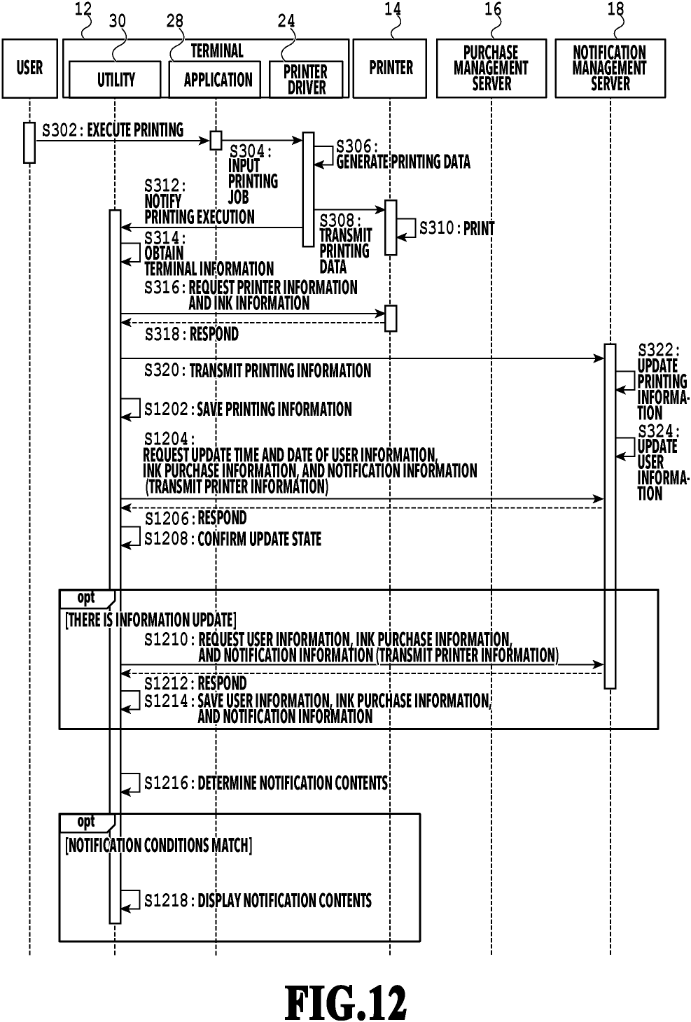

This determination processing is processing executed in S326 in the sequence diagram in FIG. 3. FIG. 9 is a flowchart illustrating a detailed processing routine of the determination processing. FIG. 10A is a flowchart illustrating a processing routine of first processing that is a subroutine of the processing routine of the determination processing illustrated in FIG. 9. FIG. 10B is a flowchart illustrating a processing routine of second processing that is a subroutine of the processing routine of the determination processing illustrated in FIG. 9. FIG. 11A is a flowchart illustrating a processing routine of third processing that is a subroutine of the processing routine of the determination processing illustrated in FIG. 9. FIG. 11B is a flowchart illustrating a processing routine of fourth processing that is a subroutine of the processing routine of the determination processing illustrated in FIG. 9.

A series of the processing illustrated in the flowcharts in FIGS. 9 to 11B is performed by the CPU 202 in the notification management server 18 deploying and executing the program code stored in the ROM 206 into the RAM 204. Alternatively, a part of or all the functions of the steps in FIGS. 9 to 11B may be executed by hardware such as an ASIC or an electric circuit. Note that, a reference numeral S in the descriptions of each processing means a step in the flowcharts (hereinafter, the same applies in the present specification). Note that, in the descriptions of the determination processing in the present embodiment, descriptions are given assuming that the notification control part 54 as a functional configuration implemented by the CPU 202 executes each processing of the determination processing in the notification management server 18.

In the determination processing, first, the notification control part 54 obtains the printing information from the printing information management part 48 (S902). That is, in S902, the printing information in the printing information management part 48 that is updated in S322 is obtained. Thus, in the present embodiment, the notification control part 54 functions as an obtainment unit that obtains the ink information that is the remaining amount information on the ink (included in the printing information). Additionally, the notification control part 54 obtains the user information including the printer information on the printer 14 that executes printing from the user information management part 50 (S904). That is, in 904, the user information in the user information management part 50 that is updated in S324 is obtained. Thus, in the present embodiment, the notification control part 54 functions as an obtainment unit that obtains the terminal information on the terminals 12 sharing the printer 14 (included in the user information).

Next, the notification control part 54 obtains a total number T of the terminals of the users sharing the printer 14 (S906). In S906, for example, a total number of the terminal user IDs or a total number of the terminal serial numbers in the terminal information included in the user information obtained in S904 is obtained. The notification control part 54 then determines whether the printer 14 is shared by multiple terminals (S908). In S908, whether the total number T obtained in S906 is 2 or greater is determined. If the total number T is 2 or greater, it is determined that the printer 14 is shared by multiple terminals, and if the total number T is not 2 or greater, that is, 1, it is determined that the printer 14 is not shared by multiple terminals.

In S908, if it is determined that the printer 14 is not shared by multiple terminals, the processing proceeds to S916 described later. On the other hand, in S908, if it is determined that the printer 14 is shared by multiple terminals, the notification control part 54 initializes a terminal index N (N is a natural number), that is, sets N = 1 (S910). In the terminal information in the user information, for example, a terminal index may be set for each user ID of the terminal, or terminal indexes may be set sequentially from the top cell. The notification control part 54 then obtains the ink purchase information including the printer information on the printer 14 that executes printing from the purchase information management part 46 (S912). That is, in S912, the ink purchase information including the printer information matching the printer information included in the printing information obtained in S902 is obtained. Thus, in the present embodiment, the notification control part 54 functions as an obtainment unit that obtains the ink purchase information that is the purchase authority information.

Thereafter, the notification control part 54 determines whether there is a user able to purchase ink in the ink purchase information (S914). In S914, whether there is the terminal information in the ink purchase information obtained in S912 is determined. In the ink purchase information, if there is no terminal information, it is determined that there is no user able to purchase ink, and if there is the terminal information, it is determined that there is a user able to purchase ink.

In S914, if it is determined that there is no user able to purchase ink, the notification control part 54 executes the first processing (S916). In the first processing in S916, as illustrated in FIG. 10A, first, based on the printing information obtained in S902, the notification control part 54 determines whether the remaining amount level of at least one ink in the printer 14 is less than 20% (S1002). The ink information indicating the remaining amount level of each ink is included in the printing information (see FIG. 4A), and in S1002, whether the remaining amount level of each ink is less than 20% is determined based on this ink information.

In S1002, if it is determined that none of the remaining amount levels of the inks in the printer 14 are less than 20%, the notification control part 54 determines not to make a notification as the notification contents (1004), and the processing proceeds to S918. On the other hand, in S1002, if it is determined that the remaining amount level of at least one ink in the printer 14 is less than 20%, the notification control part 54 determines to immediately make a notification of the ink discount information as the notification contents, and the processing proceeds to S918. Thus, the notification contents determined after this first processing are notification contents according to the notification conditions of the notification settings (8) and (9) in FIG. 5.

Referring back to FIG. 9. In S918, the notification control part 54 determines whether there is a next terminal sharing the printer 14. Specifically, in S918, whether there is the terminal 12 for which no notification contents are determined yet is determined. If it is determined that there is the terminal for which no notification contents are determined yet, it is determined that there is the next terminal sharing the printer 14, and if it is determined that there is no terminal for which no notification contents are determined yet, it is determined that there is no next terminal sharing the printer 14. In S918, if it is determined that there is no next terminal sharing the printer 14, this determination processing ends. On the other hand, in S918, if it is determined that there is the next terminal sharing the printer 14, N is incremented (S920), and the processing proceeds to S922 described later.

On the other hand, in S914, if it is determined that there is a user able to purchase ink, whether the terminal 12 with the terminal index N has the authority of ink purchase is determined (S922). In S922, whether there is the user ID of the terminal 12 with the terminal index N in the terminal information in the ink purchase information is determined. In S922, if there is the user ID of the terminal 12 with the terminal index N in the terminal information in the ink purchase information, it is determined that the terminal 12 with the terminal index N has the authority of ink purchase. Additionally, in S922, if there is no user ID of the terminal 12 with the terminal index N in the terminal information in the ink purchase information, it is determined that the terminal 12 with the terminal index N has no authority of ink purchase.

In S922, if it is determined that the terminal 12 with the terminal index N has no authority of ink purchase, the notification control part 54 executes the second processing (S924), and thereafter, the processing proceeds to S918. In the second processing in S924, as illustrated in FIG. 10B, first, based on the printing information obtained in S902 and the user information obtained in S904, the notification control part 54 determines whether the user who executes printing is the user of the terminal 12 with the terminal index N (S1010). That is, in S1010, whether the user ID and the serial number of the terminal 12 with the terminal index N in the user information match the user ID and the serial number of the terminal in the terminal information in the printing information is determined. In S1010, if the user ID and the serial number of the terminal 12 with the terminal index N match the user ID and the serial number of the terminal in the printing information, it is determined that the user who executes printing is the user of the terminal 12 with the terminal index N. On the other hand, in S1010, if the user ID and the serial number of the terminal 12 with the terminal index N do not match the user ID and the serial number of the terminal in the printing information, it is determined that the user who executes printing is not the user of the terminal 12 with the terminal index N.

In S1010, if it is determined that the user who executes printing is not the user of the terminal 12 with the terminal index N, the notification control part 54 determines not to make a notification as the notification contents (S1012), and the processing proceeds to S918. Then, in S1010, if it is determined that the user who executes printing is the user of the terminal 12 with the terminal index N, the notification control part 54 determines whether the remaining amount level of at least one ink in the printer 14 is less than 5% (S1014). In S1014, based on the ink information in the printing information obtained in S902, whether the remaining amount level of each ink is less than 5% is determined.

In S1014, if it is determined that the remaining amount levels of none of the inks in the printer 14 are less than 5%, the processing proceeds to S1012. On the other hand, in S1014, if it is determined that the remaining amount level of at least one ink in the printer 14 is less than 5%, the notification control part 54 determines whether the terminal 12 that executes printing is the terminal 12 with the terminal index N (S1016). That is, in S1016, whether the terminal information on the terminal 12 with the terminal index N in the user information obtained in S904 matches the terminal information in the printing information obtained in S902 is determined. In S1016, if the terminal information on the terminal 12 with the terminal index N matches the terminal information in the printing information, it is determined that the terminal 12 that executes printing is the terminal 12 with the terminal index N. On the other hand, in S1016, if it is determined that the terminal information on the terminal 12 with the terminal index N does not match the terminal information in the printing information, it is determined that the terminal 12 that executes printing is not the terminal 12 with the terminal index N.

In S1016, if it is determined that the terminal 12 that executes printing is the terminal 12 with the terminal index N, the notification control part 54 determines to immediately make a notification of the ink-purchase-required request information as the notification contents (S1018), and the processing proceeds to S918. On the other hand, in S1016, if it is determined that the terminal 12 that executes printing is not the terminal 12 with the terminal index N, the notification control part 54 determines to make a timer notification of the ink-purchase-required request information as the notification contents (S1020), and the processing proceeds to S918. Note that, the timer notification means that a notification is made on time set in advance (in FIG. 5, 9:00 P.M.). Thus, the notification contents determined after this second processing are the notification contents according to the notification conditions of the notification settings (6) and (7) in FIG. 5.

Referring back to FIG. 9. On the other hand, in S922, if it is determined that the terminal 12 with the terminal index N has the authority of ink purchase, whether the terminal 12 with the terminal index N was used to purchase ink is determined (S926). In S926, whether there is the serial number of the terminal 12 with the terminal index N in the terminal information in the ink purchase information is determined. That is, in S926, whether the terminal 12 with the terminal index N is usable to purchase ink is determined. Accordingly, in S926, if there is the serial number of the terminal 12 with the terminal index N in the terminal information in the ink purchase information, it is determined that the terminal 12 with the terminal index N was used to purchase ink. On the other hand, in S926, if there is no serial number of the terminal 12 with the terminal index N in the terminal information in the ink purchase information, it is determined that the terminal 12 with the terminal index N was not used to purchase ink.

In S926, if it is determined that the terminal 12 with the terminal index N was not used to purchase ink, the notification control part 54 executes the third processing (S928), and thereafter, the processing proceeds to S918. In the third processing in S928, as illustrated in FIG. 11A, first, based on the printing information obtained in S902 and the user information obtained in S904, the notification control part 54 determines whether the user who executes printing is the user of the terminal 12 with the terminal index N (S1102). The specific processing contents in S1102 are the same as that in S1010.

In S1102, if it is determined that the user who executes printing is not the user of the terminal 12 with the terminal index N, the notification control part 54 determines not to make a notification as the notification contents (S1104), and the processing proceeds to S918. On the other hand, in S1102, if it is determined that the user who executes printing is the user of the terminal 12 with the terminal index N, the notification control part 54 determines whether the remaining amount level of at least one ink in the printer 14 is less than 5% (S1106). The specific processing contents in S1106 are the same as that in S1014.

In S1106, if it is determined that the remaining amount levels of none of the inks in the printer 14 are less than 5%, the processing proceeds to S1104. On the other hand, in S1106, if it is determined that the remaining amount level of at least one ink in the printer 14 is less than 5%, the notification control part 54 determines to immediately make a notification of the ink discount information as the notification contents (S1108), and the processing proceeds to S918. Thus, the notification contents determined after this third processing are notification contents according to the notification conditions of the notification setting (1) in FIG. 5.

Referring back to FIG. 9. On the other hand, in S926, if it is determined that the terminal 12 with the terminal index N was used to purchase ink, the notification control part 54 executes the fourth processing (S930), and thereafter, the processing proceeds to S918. In the fourth processing in S930, as illustrated in FIG. 11B, first, based on the printing information obtained in S902 and the user information obtained in S904, the notification control part 54 determines whether the user who executes printing is the user of the terminal 12 with the terminal index N (S1110). The specific processing contents in S1110 are the same as that in S1010.

In S1110, if it is determined that the user who executes printing is the user of the terminal 12 with the terminal index N, the notification control part 54 determines whether the remaining amount level of at least one ink in the printer 14 is less than 20% (S1112). The specific processing contents in S1112 are the same as that in S1002. In S1112, if it is determined that the remaining amount levels of none of the inks in the printer 14 are less than 20%, the notification control part 54 determines not to make a notification as the notification contents (S1114), and the processing proceeds to S918. On the other hand, in S1112, if it is determined that the remaining amount level of at least one ink in the printer 14 is less than 20%, the notification control part 54 determines whether the terminal 12 that executes printing is the terminal 12 with the terminal index N (S1116). The specific processing contents in S1116 are the same as that in S1016.

In S1116, if it is determined that the terminal 12 that executes printing is the terminal 12 with the terminal index N, the notification control part 54 determines to immediately make a notification of the ink discount information as the notification contents (S1118), and the processing proceeds to S918. On the other hand, in S1116, if it is determined that the terminal 12 that executes printing is not the terminal 12 with the terminal index N, the notification control part 54 determines to make a timer notification of the ink discount information as the notification contents (S1120), and the processing proceeds to S918.

On the other hand, in S1110, if it is determined that the user who executes printing is not the user of the terminal 12 with the terminal index N, the notification control part 54 determines whether there is the user ID of the terminal 12 that executes printing in the ink purchase information (S1122). In S1122, whether there is the user ID of the terminal in the printing information obtained in S902 is in the user IDs of the terminals in the ink purchase information obtained in S912 is determined. In S1122, if it is determined that there is the user ID of the terminal 12 that executes printing in the ink purchase information, the notification control part 54 determines whether the remaining amount level of at least one ink in the printer 14 is less than 5% (S1124). The specific processing contents in S1124 is the same as that in S1014.

In S1124, if it is determined that the remaining amount levels of none of the inks in the printer 14 are less than 5%, the processing proceeds to S1114. On the other hand, in S1124, if it is determined that the remaining amount level of at least one ink in the printer 14 is less than 5%, the notification control part 54 determines to make a timer notification of the ink discount information as the notification contents (S1126), and the processing proceeds to S918. On the other hand, in S1122, if it is determined that there is no user ID of the terminal 12 that executes printing in the ink purchase information, the notification control part 54 determines whether the remaining amount level of at least one ink in the printer 14 is less than 20% (S1128). The specific processing contents in S1128 is the same as that in S1002.

In S1128, if it is determined that the remaining amount levels of none of the inks in the printer 14 are less than 20%, the processing proceeds to S1114. On the other hand, in S1128, if it is determined that the remaining amount level of at least one ink in the printer 14 is less than 20%, the notification control part 54 determines to make a timer notification of the ink discount information as the notification contents (S1130), and the processing proceeds to S918. Thus, the notification contents determined after the fourth processing are the notification contents according to the notification conditions of the notification settings (2), (3), (4), and (5) in FIG. 5.

Thus, in the fourth processing, for the terminal 12 of the user who executes printing, the timing of notification is changed depending on whether the terminal is the terminal 12 that executes printing. Specifically, since the terminal 12 that was used for ink purchase can immediately purchase ink by using the terminal 12, the ink discount information is immediately notified. Additionally, in a case of the terminal 12 that was not used for ink purchase, it can be considered that ink may not be purchased by using the terminal 12; for this reason, the ink discount information is notified on set time. Thus, the notification control part 54 controls notifications such that the ink discount information is displayed in an appropriate timing.

Moreover, in the fourth processing, for the terminal 12 of the user who does not execute printing, the threshold of the remaining amount level of the ink for notification of the ink discount information is changed depending on whether the user has the ink purchase authority. Specifically, it can be considered that the user having no ink purchase authority cannot easily deal with the ink purchase; for this reason, the ink discount information is notified on set time with the remaining amount level of less than 20%, which is in a relatively early stage. On the other hand, it can be considered that the user having the ink purchase authority can easily deal with the ink purchase; for this reason, the ink discount information is notified on set time with the remaining amount level of less than 5%, which is in a relatively late stage. Thus, the notification control part 54 controls notifications such that the ink discount information is not unnecessarily displayed to the user of the terminal 12 that executes no printing.

Thus, in the present embodiment, the notification contents and the notification timing are determined in the notification management server 18, and the notification management server 18 functions as an information processing apparatus that makes notifications to the terminals 12 of the users sharing a consumable (ink in the printer 14).

As described above, in the present embodiment, once printing is executed in the printer 14, the printing information and the user information are obtained in the terminal 12 that requests printing, and thereafter, those pieces of information are transmitted to the notification management server 18. Then, in the notification management server 18, based on the ink purchase information and the notification setting together with the received printing information and user information, the terminals of the users sharing the printer 14 are notified of the information on purchase of ink and the like. Specifically, notifications are made with different notification contents and notification timings depending on whether the user of the terminal 12 has the ink purchase authority, whether the terminal 12 was used to purchase ink, and the like. With this, it is possible to appropriately notify the terminals of the users sharing the printer 14 of the information on purchase of ink such as the ink discount information, and it is possible to suppress an unnecessary notification. That is, it is possible to execute notification processing that is convenient for the user.

### Second Embodiment

Next, an information processing apparatus in a second embodiment is described with reference to FIGS. 12 to 16. Note that, in the following descriptions, reference numerals same as that used in the first embodiment are used for a configuration same as or corresponding to that of the information processing apparatus in the above-described first embodiment; for this reason, detailed descriptions thereof are omitted.

The second embodiment is different from the above-described first embodiment in that, the information on purchase of ink according to the notification conditions is determined and notified as the notification contents in the terminal 12. That is, in the second embodiment, determination on the notification contents executed by the notification management server 18 and the like in the first embodiment are executed by the terminal 12.

In the present embodiment, each of the printing information, the user information, the ink purchase information, the ink discount information, the notification information, and the like held in the terminal 12 and the notification management server 18 is associated with the information on the update time and date (hereinafter, referred to as “update time and date information”). In the terminal 12 and the notification management server 18, once the various pieces of information are obtained from the notification management server 18, those pieces of information are saved and updated, and also the time and date on which the update is performed is saved as the update time and date information. Additionally, in the purchase management server 16, once the ink purchase information is updated, the time and date on which the update is performed is saved as the update time and date information. Note that, in the present embodiment, the notification information is the notification setting in which the notification contents according to the notification conditions are set. This notification information is not limited to only the notification setting and may include information for various notifications displayed on the ink information screen 702. Accordingly, the notification information is saved in the notification setting part 52.

### <Notification Processing in Printing System>

In the present embodiment, in a case of printing-execution in which printing is executed, the notification contents are determined and a notification is made in the terminal 12 that executes printing, and in a case of no-printing-execution in which no printing is executed, the above-described notification is made in all the terminals 12 sharing the printer 14. The notification processing in a case of printing-execution and that in a case of no-printing-execution executed in the present embodiment are described in detail.

### =Notification Processing in Case of Printing-Execution=

FIG. 12 is a diagram illustrating a processing sequence of the notification processing in a case of printing-execution in the printing system 10 in the present embodiment. Note that, in FIG. 12, the same step number is used to illustrate processing of the processing contents same as that in the processing sequence in FIG. 3. For this reason, in the following descriptions, detailed descriptions of the processing with the same step number as that in FIG. 3 are omitted. Additionally, in FIG. 12, the processing after the user selects the “purchase” button 720 and the “order” button 816 on the ink information screen 702 is the same as that in S332 to S354 in FIG. 3; for this reason, illustration of the processing is omitted, and descriptions of the processing in the following descriptions are omitted.

In the notification processing in a case of printing-execution, once the user requests printing in S302, the printing job is generated and outputted in S304, the printing data is generated in S306, the printing data is transmitted to the printer 14 in S308, and the printer 14 executes printing in S310. Additionally, the printer driver 24 notifies the utility 30 of that printing is executed in S312, and the utility 30 obtains the user ID and the serial number of the self-terminal in S314. The utility 30 then requests the printer 14 to provide the model name and the serial number of the printer 14 and the ink information in S316, and the response from the printer 14 is obtained in S318.

Thereafter, in S320, after the utility 30 transmits the printing information and the printer information to the notification management server 18, the utility 30 saves the printing information in the storage region such as the RAM 204 of the terminal 12 (S1202). In S1202, the utility 30 saves the time and date on which the printing information is saved as the update time and date information in association with the printing information.

Next, the utility 30 requests the notification management server 18 to provide the update time and date information on the user information, the ink purchase information, and the notification information including the printer information on the printer 14 that executes printing (S1204) and obtains the response (S1206). Thereafter, the utility 30 confirms the obtained update states of the user information, the ink purchase information, and the notification information (S1208). In S1208, the utility 30 compares the update time and date information on the user information, the ink purchase information, and the notification information saved in the terminal 12 with the update time and date information on each piece of information obtained in S1206. Then, if the information saved in the terminal 12 and the information obtained in S1206 are different from each other, it is determined that the user information, the ink purchase information, and the notification information are updated. On the other hand, if the information saved in the terminal 12 and the information obtained in S1206 match with each other, it is determined that the user information, the ink purchase information, and the notification information are not updated.

Then, during the confirmation of the update state in S1208, if the user information, the ink purchase information, and the notification information are not updated, the utility 30 allows the processing to proceed to S1216 described later. On the other hand, during the confirmation of the update state in S1208, if the user information, the ink purchase information, and the notification information are updated, the utility 30 requests the notification management server 18 to provide information in which the update time and date information is updated (S1210) and obtains the response (S1212). The utility 30 saves the information obtained in S1212 in the storage region of the terminal 12 together with the update time and date information on the information (already obtained in S1206) (S1214).

Thereafter, based on the terminal information on the self-terminal and the printing information, the user information, the ink purchase information, and the notification setting included in the notification information saved in the self-terminal, the utility 30 determines the notification contents (S1216). The utility 30 then displays the determined notification contents together with the printer information and the ink information on the ink information screen 702 displayed on the display 210 of the self-terminal to make a notification (1218).

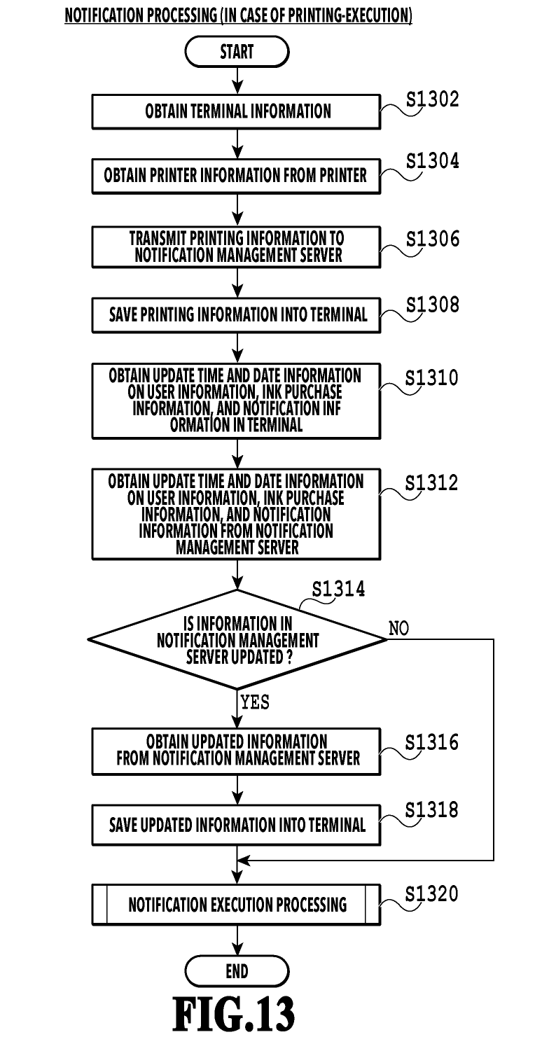

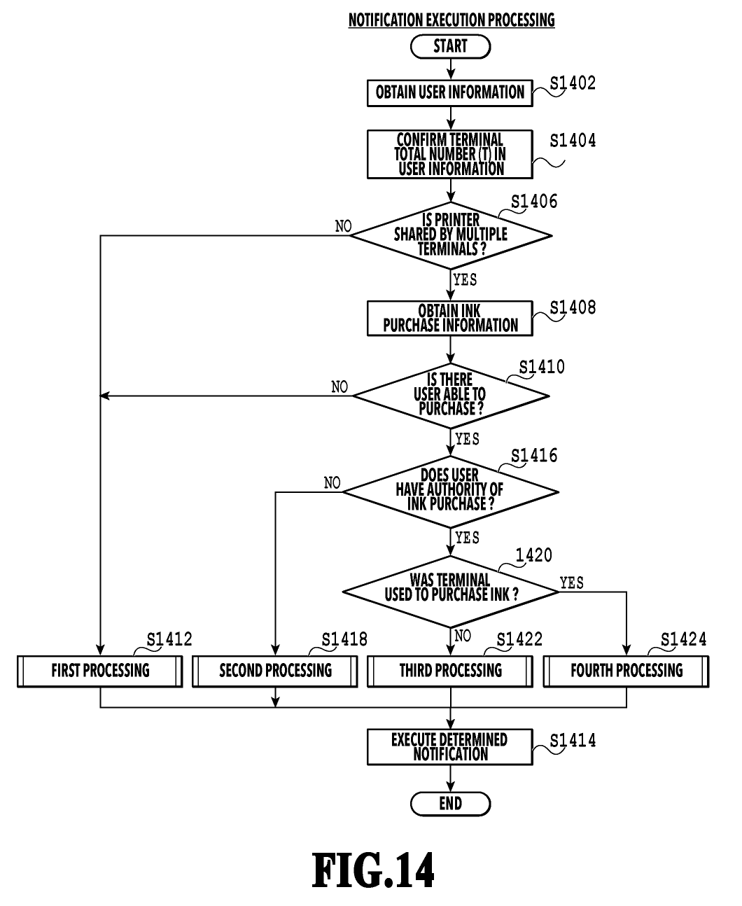

Next, specific processing contents in the terminal 12 in the notification processing in a case of printing-execution are described with reference to the flowchart in FIG. 13. FIG. 13 is a flowchart illustrating a detailed processing routine of notification processing executed by the terminal 12 in the notification processing in a case of printing-execution in the present embodiment. FIG. 14 is a flowchart illustrating a processing routine of notification execution processing that is a subroutine of the processing routine of the notification processing illustrated in FIG. 13. A series of processing illustrated in the flowcharts in FIGS. 13 and 14 is performed by the CPU 202 in the terminal 12 deploying and executing the program code stored in the ROM 206 into the RAM 204. Alternatively, a part of or all the functions of the steps in FIGS. 13 and 14 may be executed by hardware such as an ASIC or an electric circuit. Note that, in the descriptions of this notification processing, descriptions are given assuming that the utility 30 that is software executed by the CPU 202 in the terminal 12 executes processing in each step.

Once being notified of execution of printing from the printer driver 24 (corresponding to S312), the utility 30 starts the notification processing. Once this notification processing is started, first, the utility 30 obtains the user ID and the serial number of the self-terminal as the terminal information on the self-terminal (S1302). This S1302 corresponds to S314 in FIG. 12. In S1302, the user ID and the serial number of the self-terminal held in the storage region of the self-terminal are obtained.

The utility 30 then obtains from the printer 14 the model name and the serial number of the printer as the printer information and the ink information indicating the remaining amount level of the ink mounted in the printer 14 (S1304). This S1304 corresponds to S316 and S318 in FIG. 12. Thus, in the present embodiment, the utility 30 functions as an obtainment unit that obtains the ink information that is the remaining amount information on ink.

Next, the utility 30 transmits the printing information including the terminal information and the printer information to the notification management server 18 (S1306). This S1306 corresponds to S320 in FIG. 12. That is, in S1306, the utility 30 creates the printing information including the terminal information obtained in S1302 and the printer information obtained in S1304 and transmits the printing information to the notification management server 18. In the notification management server 18, once receiving the printing information, the printing information held in the printing information management part 48 is updated to the received printing information (corresponding to S322 in FIG. 12). Then, in the notification management server 18, if the terminal information included in the received printing information is not included in the user information, the terminal information is added to the user information to update the user information (corresponding to S324 in FIG. 12).

Thereafter, the utility 30 saves the printing information transmitted in S1306 into the storage region of the self-terminal in association with the update time and date information that is the time and date on which the saving is performed (S1308). This S1308 corresponds to S1202 in FIG. 12. Additionally, the utility 30 obtains the update time and date information on the user information, the ink purchase information, and the notification information saved in the self-terminal (S1310). Moreover, the utility 30 obtains the update time and date information on the user information, the ink purchase information, and the notification information from the notification management server 18 (S1312). This S1312 corresponds to S1204 and S1206 in FIG. 12. Thus, in the present embodiment, the utility 30 functions as an obtainment unit that obtains the terminal information on the terminal devices sharing the printer 14, the purchase authority information that is the information on whether there is the authority of ink purchase, and the notification information.

Once obtaining the update time and date information on the user information and the like, the utility 30 determines whether the user information, the ink purchase information, and the notification information in the notification management server 18 are updated (S1314). This S1314 corresponds to S1208 in FIG. 12. That is, in S1314, for each of the user information, the ink purchase information, and the notification information, that obtained in S1310 is compared with that obtained in S1312, and whether at least one of the pieces of information is different is determined. Then, if all the pieces of information obtained in S1310 and that obtained in S1312 are the same, in S1314, it is determined that the pieces of information are not updated. On the other hand, if at least one of the user information, the ink purchase information, and the notification information is different between that obtained in S1310 and that obtained in S1312, in S1314, it is determined that the pieces of information are updated.

In S1314, if it is determined that the user information, the ink purchase information, and the notification information in the notification management server 18 are not updated, the processing proceeds to S1320 described later. On the other hand, in S1314, if it is determined that the user information, the ink purchase information, and the notification information in the notification management server 18 are updated, the utility 30 obtains the updated information from the notification management server 18 (S1316). This S1316 corresponds to S1210 and S1212 in FIG. 12. That is, in S1316, the information out of the user information, the ink information, and the notification information that is determined in S1314 to be different between that obtained in S1310 and that obtained in S1312 is obtained from the notification management server 18.

Then, the utility 30 saves the information obtained in S1316 into the storage region of the self-terminal (S1318). This S1318 corresponds to S1214 in FIG. 12. In S1318, the update time and date information on the saved information is updated to the update time and date information obtained in S1312. That is, in S1318, in the self-terminal, for example, in a case where the notification information is updated, the update time and date information associated with the notification information is updated to the update time and date information obtained in S1312. Then, based on the information saved in the self-terminal, the utility 30 performs the notification execution processing in which the notification contents are determined and also the determined notification contents are notified (S1320), and the utility 30 ends this notification processing. This S1320 corresponds to S1216 and S1218 in FIG. 12. Thus, in the present embodiment, the utility 30 functions as a notification unit that determines the notification contents.

In S1320, the notification execution processing illustrated in FIG. 14 is performed. Once the notification execution processing is started, first, the utility 30 obtains the user information saved in the self-terminal (S1402). The utility 30 then obtains the total number T of the terminals from the terminal information included in the user information (S1404). In S1404, for example, the total number of the terminal user IDs or the total number of the terminal serial numbers in the terminal information in the user information is obtained.

Next, the utility 30 determines whether the printer 14 usable by the self-terminal is shared by multiple terminals (S1406). In S1406, whether the number of the total number T obtained in S1404 is 2 or greater is determined. If the total number T is 2 or greater, it is determined that the printer 14 is shared by multiple terminals, and if the total number T is not 2 or greater, that is, 1, it is determined that the printer 14 is not shared by multiple terminals.

In S1406, if it is determined that the printer 14 is not used by multiple terminals, the processing proceeds to S1412 described later. On the other hand, in S1406, if it is determined that the printer 14 is used by multiple terminals, the utility 30 obtains the ink purchase information saved in the self-terminal (S1408). The utility 30 then determines whether there is the terminal 12 that purchased ink (S1410). That is, in S1410, whether there is the terminal information in the ink purchase information is determined. If there is no terminal information in the ink purchase information, it is determined that there is no terminal 12 that purchased ink, and if there is the terminal information, it is determined that there is the terminal 12 that purchased ink.

In S1410, if it is determined that there is no terminal 12 that purchased ink, the utility 30 executes the first processing (S1412) and makes a notification of the determined notification contents (S1414). The specific processing contents of the first processing in S1412 are the same as the first processing in S916 described in the first embodiment except that the processing is executed by the utility 30 instead of the notification control part 54; for this reason, detailed descriptions thereof are omitted. That is, each processing illustrated in FIG. 10A is executed by the utility 30 in the first processing in S1412.

On the other hand, in S1410, if it is determined that there is the terminal 12 that purchased ink, the utility 30 determines whether the user holding the self-terminal has the authority of ink purchase (S1416). In S1416, whether there is the user ID of the self-terminal in the terminal information in the ink purchase information is determined. Accordingly, in S1416, if there is the user ID of the self-terminal in the terminal information in the ink purchase information, it is determined that the user holding the self-terminal has the authority of ink purchase. On the other hand, in S1416, if there is no user ID of the self-terminal in the terminal information in the ink purchase information, it is determined that the user holding the self-terminal has no authority of ink purchase.

In S1416, if it is determined that the self-terminal has no authority of ink purchase, the utility 30 executes the second processing (S1418), and the processing proceeds to S1414. The specific processing contents of the second processing in S1418 are the same as the second processing in S924 described in the first embodiment except that the processing is executed by the utility 30 instead of the notification control part 54; for this reason, detailed descriptions thereof are omitted. That is, each processing illustrated in FIG. 10B is executed by the utility 30 in the second processing in S1418.

On the other hand, in S1416, if it is determined that the user holding the self-terminal has the authority of ink purchase, the utility 30 determines whether the self-terminal was used to purchase ink (S1420). In S1420, whether there is the serial number of the self-terminal in the terminal information in the ink purchase information is determined. That is, in S1420, whether the self-terminal is usable to purchase ink is determined. Accordingly, in S1420, if there is the serial number of the self-terminal in the terminal information in the ink purchase information, it is determined that the self-terminal was used to purchase ink. On the other hand, in S1420, if there is no serial number of the self-terminal in the terminal information in the ink purchase information, it is determined that the self-terminal was not used to purchase ink.

In S1420, if it is determined that the self-terminal was not used to purchase ink, the utility 30 executes the third processing (S1422), and the processing proceeds to S1414. The specific processing contents of the third processing in S1422 are the same as the third processing in S928 described in the first embodiment except that the processing is executed by the utility 30 instead of the notification control part 54; for this reason, detailed descriptions thereof are omitted. That is, each processing illustrated in FIG. 11A is executed by the utility 30 in the third processing in S1422.

In S1420, if it is determined that the self-terminal was used to purchase ink, the utility 30 executes the fourth processing (S1424), and the processing proceeds to S1414. The specific processing contents of the fourth processing in S1424 are the same as the fourth processing in S930 described in the first embodiment except that the processing is executed by the utility 30 instead of the notification control part 54; for this reason, detailed descriptions thereof are omitted. That is, each processing illustrated in FIG. 11B is executed by the utility 30 in the fourth processing in S1424.

### =Notification Processing in Case of No-Printing-Execution=

Next, notification processing in a case of no-printing-execution in which no printing is executed is described. In the first embodiment, in a case of printing-execution, the notification contents are determined and notified to the terminals 12 sharing the printer 14 that performs printing. In contrast, in the present embodiment, as described above, in a case of printing-execution, the notification contents are determined and notified in the terminal 12 that requests (executes) printing. Note that, in the present embodiment, the notification contents are determined and notified by the notification processing in a case of no-printing-execution to the terminals 12 sharing the printer 14 that performs printing including the terminal 12 that requests printing.

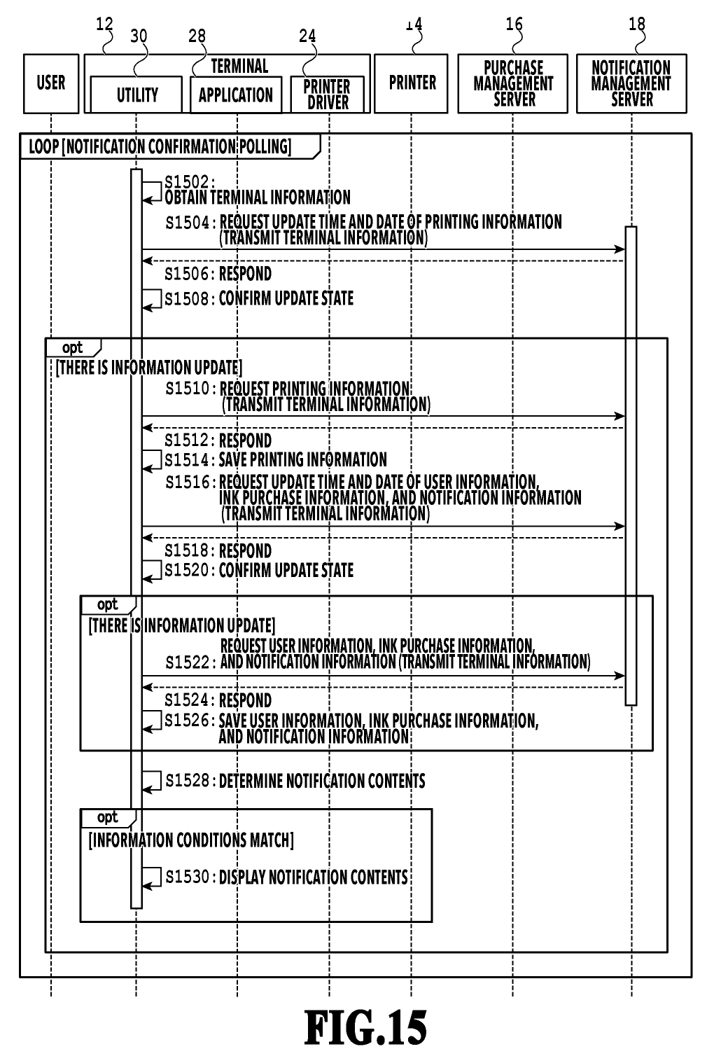

In a case of no-printing-execution, the notification processing is executed in a predetermined timing. The predetermined timing may be, for example, every predetermined time, at activation of the terminal 12, or the like. Specifically, in a case of no-printing-execution, for example, the notification processing is executed every hour. In this notification processing, the utility 30 confirms the printing state from the notification management server 18 and determines the notification contents and the like based on the confirmation result to make a notification. FIG. 15 is a diagram illustrating a processing sequence of the notification processing in a case of no-printing-execution in the printing system 10 in the present embodiment.

Once the notification processing in a case of no-printing-execution is started, first, the utility 30 obtains the user ID and the serial number of the self-terminal as the terminal information (S1502). In S1502, the user ID and the serial number of the terminal 12 stored in the storage region of the self-terminal are obtained. The utility 30 then transmits the terminal information obtained in S1502 to the notification management server 18, requests the update time and date information on the printing information in the printer 14 used by the self-terminal (S1504), and obtains the response (S1506).

Next, the utility 30 confirms the update state of the printing information (S1508). In S1508, the update time and date information on the printing information saved in the printer 14 that is obtained in S1506 is compared with the update time and date information on the printing information saved in the self-terminal. In S1508, if the printing information is not updated, that is, if the update time and date information obtained in S1506 matches the update time and date information on the printing information saved in the self-terminal, the notification processing ends. In the terminal 12 that requests the latest printing, the update time and date information on the printing information in the terminal 12 is updated in the notification processing in a case of printing-execution; thus, in S1508, the update time and date information obtained in S1506 matches the update time and date information saved in the self-terminal.

On the other hand, in S1508, if it is determined that the printing information is updated, that is, if it is determined that the update time and date information obtained in S1506 does not match the update time and date information on the printing information saved in the self-terminal, the utility 30 requests the notification management server 18 to provide the printing information (S1510). The utility 30 then obtains the response (S1512). In S1510, the utility 30 transmits the terminal information on the self-terminal together with the above-described request. With this, the notification management server 18 that receives the request transmits the requested information to the terminal 12 of the received terminal information.

Thereafter, the utility 30 saves the printing information obtained in S1512 into the storage region of the self-terminal in association with the update time and date information obtained in S1506 (S1514). Additionally, the utility 30 requests the notification management server 18 to provide the update time and date information on the user information, the ink purchase information, and the notification information (S1516) and obtains the response (S1518). In S1516, the terminal information on the self-terminal is transmitted together with the above-described request. With this, the notification management server 18 that receives the request transmits the requested information to the terminal 12 of the received terminal information. The utility 30 then confirms the update state of each of the user information, the ink purchase information, and the notification information (S1520). In S1520, for each of the user information, the ink purchase information, and the notification information, the update time and date information obtained in S1518 is compared with the update time and date information saved in the self-terminal.

In S1520, if it is determined that none of the user information, the ink purchase information, and the notification information are updated, that is, the update time and date information obtained in S1518 matches the update time and date information saved in the self-terminal, the processing proceeds to S1528 described later. On the other hand, in S1520, if it is determined that at least one of the user information, the ink purchase information, and the notification information is updated, the utility 30 requests the notification management server 18 to provide the updated information (S1522) and obtains the response (S1524).

The utility 30 then saves the information obtained in S1524 into the storage region of the self-terminal in association with the update time and date information obtained in S1518 (S1526). Additionally, the utility 30 determines the notification contents based on the printing information, the user information, the ink purchase information, and the notification setting saved in the self-terminal (S1528). The utility 30 then displays the determined notification contents together with the printer information and the ink information on the ink information screen 702 displayed on the display 210 of the self-terminal to make a notification (1530).

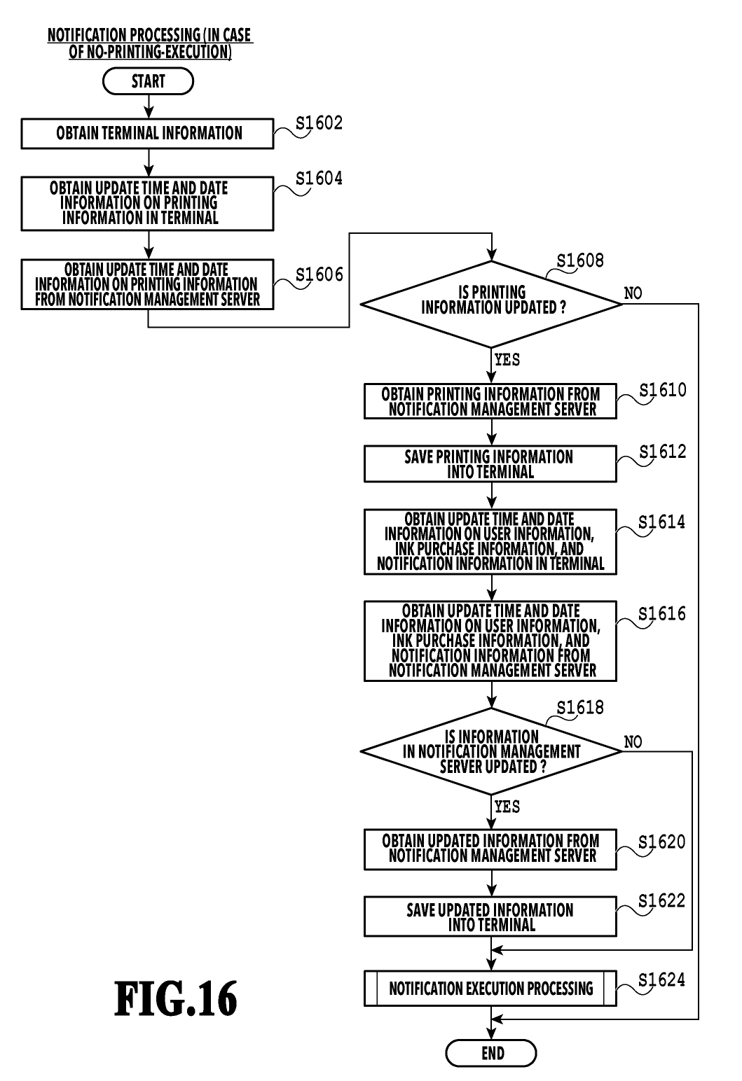

Next, specific processing contents in the terminal 12 in the notification processing in a case of no-printing-execution are described with reference to a flowchart in FIG. 16. FIG. 16 is a flowchart illustrating a detailed processing routine of the notification processing executed in the terminal 12 in the notification processing in a case of no-printing-execution in the present embodiment. A series of the processing illustrated in the flowchart in FIG. 16 is performed by the CPU 202 in the terminal 12 deploying and executing the program code stored in the ROM 206 into the RAM 204. Alternatively, a part of or all the functions of the steps in FIG. 16 may be executed by hardware such as an ASIC or an electric circuit. Note that, in the descriptions of this notification processing, descriptions are given assuming that the utility 30 that is software executed by the CPU 202 in the terminal 12 executes processing in each step.

In a predetermined timing that is, for example, after the elapse of one hour from end of the notification processing in a case of no-printing-execution, the terminal 12 starts the notification processing illustrated in FIG. 16. Once this notification processing is started, first, the utility 30 obtains the user ID and the serial number of the self-terminal as the terminal information on the self-terminal (S1602). This S1602 corresponds to S1502 in FIG. 15. Additionally, the utility 30 obtains the update time and date information on the printing information saved in the self-terminal (S1604). The printing information saved in the terminal 12 is associated with the update time and date information indicating the time and date on which the update is performed. Accordingly, in S 1604, in the storage region of the self-terminal, the update time and date information saved in association with the printing information is obtained.

Next, the utility 30 obtains the update time and date information on the printing information from the notification management server 18 (S1606). This S1606 corresponds to S1504 and S1506 in FIG. 15. The utility 30 then determines whether the printing information is updated (S1608). This S1608 corresponds to S1508 in FIG. 15. In S1608, whether the update time and date information obtained in S1604 matches the update time and date information obtained in S1606 is determined. In S1608, if the update time and date information obtained in S1604 matches the update time and date information obtained in S1606, it is determined that the printing information is not updated, and if the update time and date information obtained in S1604 does not match the update time and date information obtained in S1606, it is determined that the printing information is updated.

In S1608, if it is determined that the printing information is not updated, this communication processing ends. On the other hand, in S1608, if it is determined that the printing information is updated, the utility 30 obtains the printing information from the notification management server 18 (S1610). The utility 30 then saves the obtained printing information into the storage region of the self-terminal in association with the update time and date information obtained in S1606 (S1612). S1610 corresponds to S1510 and S1512 in FIG. 15, and S1612 corresponds to S1514 in FIG. 15. Thus, in the present embodiment, the utility 30 functions as an obtainment unit that obtains the ink information that is the remaining amount information on the ink. The utility 30 then obtains the update time and date information on the user information, the ink purchase information, and the notification information saved in the self-terminal (S1614). Additionally, the utility 30 obtains the update time and date information on the user information, the ink purchase information, and the notification information from the notification management server 18 (S1616). This S1616 corresponds to S1516 and S1518 in FIG. 15.

Once obtaining the update time and date information on the user information and the like, the utility 30 determines whether the user information, the ink purchase information, and the notification information in the notification management server 18 are updated (S1618). This S1618 corresponds to S1520 in FIG. 15. That is, in S1618, for each of the user information, the ink purchase information, and the notification information, that obtained in S1614 is compared with that obtained in S1616, and whether at least one of the information is different is determined. Then, if that obtained in S1614 and that obtained in S1616 are all the same, it is determined that no information is updated in S1618. On the other hand, if at least one of the user information, the ink purchase information, and the notification information is different between that obtained in S1614 and that obtained in S1616, it is determined that the information is updated in S1618.

In S1618, if it is determined that the user information, the ink purchase information, and the notification information in the notification management server 18 are not updated, the processing proceeds to S1624 described later. On the other hand, in S1618, if it is determined that the user information, the ink purchase information, and the notification information in the notification management server 18 are updated, the utility 30 obtains the updated information from the notification management server 18 (S1620). S1620 corresponds to S1522 and S1524 in FIG. 15. That is, in S1620, the information, which is out of the user information, the ink purchase information, and the notification information and is determined in S1618 to be different between that obtained in S1614 and that obtained in S1616, is obtained from the notification management server 18. Thus, in the present embodiment, the utility 30 functions as an obtainment unit that obtains the terminal information on the terminal devices sharing the printer 14, the purchase authority information that is the information on whether there is the authority of ink purchase, and the notification information.

The utility 30 then saves the information obtained in S1620 into the storage region of the self-terminal to update (S1622). This S1622 corresponds to S1526 in FIG. 15. In S1622, the update time and date information on the saved information is updated to the update time and date information obtained in S1618. That is, in S1622, in the self-terminal, for example, in a case where the ink purchase information is updated, the update time and date information associated with the ink purchase information is updated to the update time and date information on the ink purchase information obtained in S1618. Thereafter, the utility 30 performs the notification execution processing based on the information saved in the self-terminal (S1624) and ends this notification processing. This S1624 corresponds to S1528 and S1530 in FIG. 15. Note that, specific processing contents of the notification execution processing in S1624 is the same as that in S1320 in the notification processing in a case of printing-execution; for this reason, detailed descriptions thereof are omitted. Thus, in the present embodiment, the utility 30 functions as a notification unit that determines the notification contents.

As described above, in the present embodiment, in the terminal 12, the notification contents are determined and notified based on the printing information, the printer information, the ink purchase information, the notification setting, and the like. With this, in addition to the operation and effect of the above-described first embodiment, it is possible to reduce the processing load of the notification management server 18.

### Third Embodiment

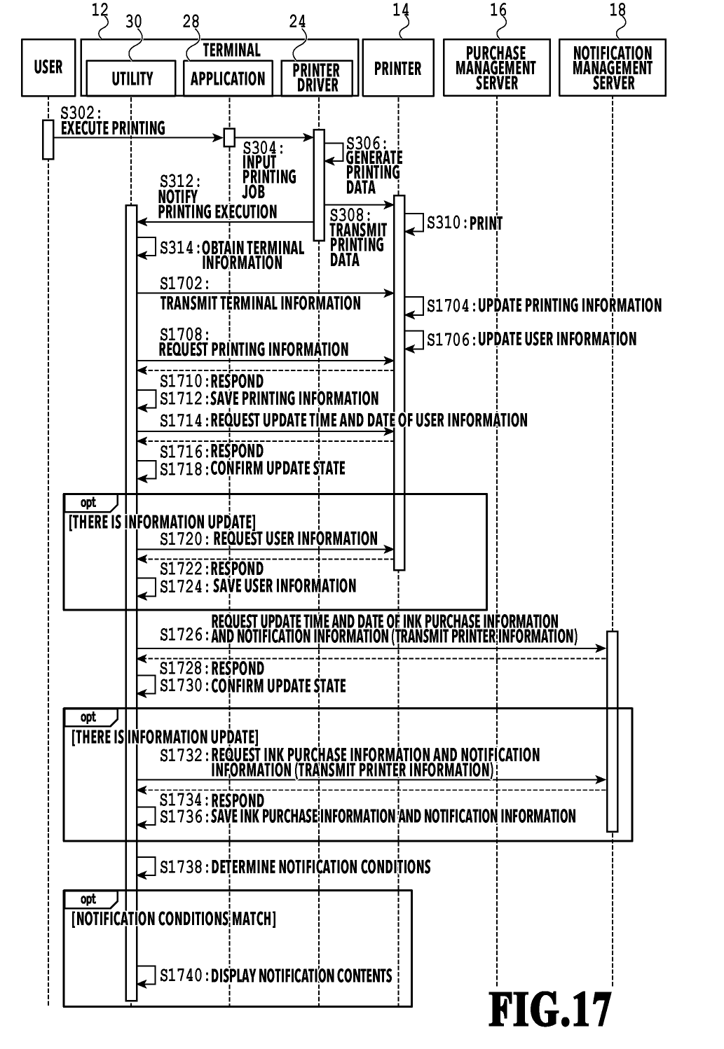

Next, the information processing apparatus of the third embodiment is described with reference to FIGS. 17 to 20. Note that, in the following descriptions, reference numerals same as that used in the first embodiment are used for a configuration same as or corresponding to that of the information processing apparatus in the above-described first embodiment; for this reason, detailed descriptions thereof are omitted.

The third embodiment is different from the above-described first embodiment in that, the information on purchase of ink according to the notification conditions is determined and notified as the notification contents in the terminal 12. Additionally, the third embodiment is different from the above-described second embodiment in that the printing information and the user information are obtained from the printer 14. That is, in the third embodiment, the printing information and the user information that are obtained from the notification management server 18 in the second embodiment are obtained from the printer 14.

In the present embodiment, each of the printing information, the user information, the ink purchase information, the ink discount information, the notification information, and the like held by the terminal 12, the printer 14, and the notification management server 18 is associated with the update time and date information. Once obtaining the various pieces of information from the printer 14 and the notification management server 18, the utility 30 saves and updates the information and also saves the time and date on which the update is performed as the update time and date information.

### <Notification Processing in Printing System>

In the present embodiment, as with the second embodiment, in a case where printing-execution in which printing is executed, notification contents are determined and notified in the terminal 12 that executes printing, and in a case of no-printing-execution in which no printing is executed, the above-described notification is made in all the terminals 12 sharing the printer 14. Hereinafter, the notification processing in a case of printing-execution and that in a case of no-printing-execution executed in the present embodiment are described in detail.

### =Notification Processing in Case of Printing-Execution=

FIG. 17 is a diagram illustrating a processing sequence of the notification processing in a case of printing-execution in the printing system 10 in the present embodiment. Note that, in FIG. 17, the same step number is used to illustrate processing of the processing contents same as that in the processing sequence in FIG. 3. For this reason, in the following descriptions, detailed descriptions of the processing with the same step number as that in FIG. 3 are omitted. Additionally, in FIG. 17, the processing after the user selects the “purchase” button 720 and the “order” button 816 on the ink information screen 702 is the same as that in S332 to S354 in FIG. 3; for this reason, illustration of the processing is omitted, and descriptions of the processing in the following descriptions are omitted.

In the notification processing in a case of printing-execution, once the user requests printing in S302, the printing job is generated and outputted in S304, the printing data is generated in S306, the printing data is transmitted to the printer 14 in S308, and the printer 14 executes printing in S310. Additionally, the printer driver 24 notifies the utility 30 of that printing is executed in S312, and the utility 30 obtains the user ID and the serial number of the self-terminal in S314.

Thereafter, the utility 30 transmits the terminal information on the self-terminal, that is, the user ID and the serial number obtained in S314 to the printer 14 (S1702). Once receiving the terminal information, the printer 14 updates the printing information (S1704), and if there is no received terminal information in the user information, the printer 14 updates the user information (S1706). In the printer 14, each of the printing information and the user information is saved in the storage region such as the ROM 256 together with the update time and date information. Accordingly, in S1704, the terminal information in the printing information saved in the storage region of the printer 14 is updated, and also the update time and date information on the printing information is updated to the time and date on which the update is performed. Additionally, in S1704, the printing information is updated such that the remaining amount of the ink after printing ends is reflected in the ink information. In S1706, whether there is the received terminal information in the terminal information in the user information is determined, and if there is the received terminal information, the user information is not updated, and if there is no received terminal information, the received terminal information is added to the terminal information in the user information to update the user information. Additionally, the update time and date information on the user information is updated to the time and date on which the user information is updated.

Additionally, once transmitting the terminal information on the self-terminal, the utility 30 requests the printer 14 to provide the printing information (S1708) and obtains the response (S1710). In S1710, the printer 14 transmits the printing information updated in S1704 and the update time and date information on the printing information to the terminal 12 that requests the printing information. Thus, in the present embodiment, the utility 30 functions as an obtainment unit that obtains the ink information that is the remaining amount information on the ink. The utility 30 then saves the printing information obtained in S1710 into the self-terminal together with the update time and date information (S1712).

Next, the utility 30 requests the printer 14 to provide the update time and date information on the user information (S1714) and obtains the response (S1716). The utility 30 then confirms the update state of the user information (S1718). In S1718, the update time and date information on the user information saved in the self-terminal is compared with the update time and date information obtained in S1716, and if the update time and date information on the user information saved in the self-terminal and the update time and date information obtained in S1716 are different from each other, it is determined that the user information is updated, and if the update time and date information on the user information saved in the self-terminal and the update time and date information obtained in S1716 match with each other, it is determined that the user information is not updated.

Then, if the user information is not updated, the processing proceeds to S1726 described later, and if the user information is updated, the utility 30 requests the printer 14 to provide the user information (S1720) and obtains the response (S1722). Thus, in the present embodiment, the utility 30 functions as an obtainment unit that obtains the terminal information on the terminal devices sharing the printer 14.

Once obtaining the user information in S1722, the utility 30 saves the obtained user information into the self-terminal (S1724). Thereafter, the utility 30 transmits the printer information to the notification management server 18, requests the update time and date information on the ink purchase information and the notification information thereof (S1726), and obtains the response (S1728). In S1726, the printer information including the model name and the serial number of the printer 14 is transmitted, and the ink purchase information including the printer information and the notification information corresponding to the printer information are requested.

Once obtaining the update time and date information on each of the ink purchase information and the notification information in S1728, the utility 30 confirms the update state of each of the ink purchase information and the notification information (S1730). In S1730, for the ink purchase information and the notification information, the update time and date information saved in the self-terminal is compared with the update time and date information obtained in S1728. For each of the ink purchase information and the notification information, if the update time and date information in the self-terminal and the update time and date information obtained in S1728 are different from each other, it is determined that the ink purchase information and the notification information are updated, and if the update time and date information in the self-terminal and the update time and date information obtained in S1728 match with each other, it is determined that the ink purchase information and the notification information are not updated.

Then, if it is determined that none of the ink purchase information and the notification information are updated, the processing proceeds to S1738 described later. If it is determined that at least one of the ink purchase information and the notification information is updated, the utility 30 requests the notification management server 18 to provide the information that is determined to be updated (S1732) and obtains the response (S1734). The utility 30 then saves the information obtained in S1734 into the self-terminal (S1736). Thus, in the present embodiment, the utility 30 functions as an obtainment unit that obtains the purchase authority information that is the information on whether there is the authority of ink purchase and the notification information.

Thereafter, the utility 30 determines the notification contents based on the terminal information on the self-terminal and the printing information, the user information, the ink purchase information, and the notification setting included in the notification information saved in the self-terminal, (S1738). The utility 30 then displays the determined notification contents together with the printer information and ink information on the ink information screen 702 displayed on the display 210 of the self-terminal to make a notification (S1740).

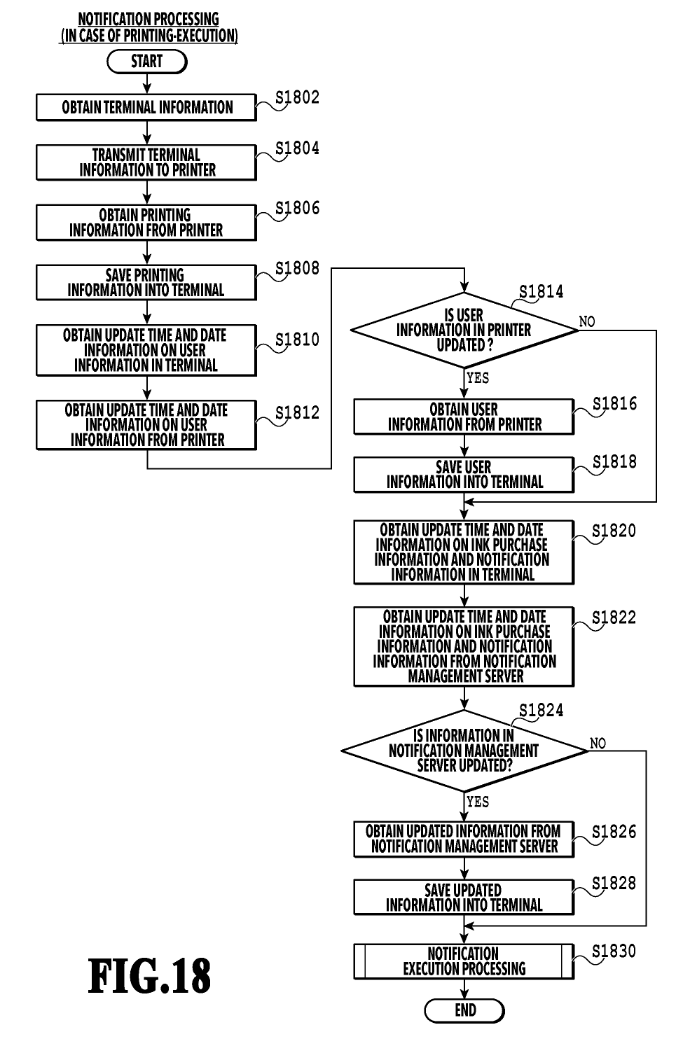

Next, the specific processing contents in the terminal 12 in the notification processing in a case of printing-execution are described with reference to a flowchart in FIG. 18. FIG. 18 is a flowchart illustrating a detailed processing routine of the notification processing that is executed in the terminal 12 in the notification processing in a case of printing-execution in the present embodiment. A series of processing illustrated in the flowchart in FIG. 18 is performed by the CPU 202 in the terminal 12 deploying and executing the program code stored in the ROM 206 into the RAM 204. Alternatively, a part of or all the functions of the steps in FIG. 18 may be executed by hardware such as an ASIC or an electric circuit. Note that, in the descriptions of this notification processing, descriptions are given assuming that the utility 30 that is software executed by the CPU 202 in the terminal 12 executes processing in each step.

Once being notified of execution of printing from the printer driver 24 (corresponding to S312), the utility 30 starts the notification processing. Once this notification processing is started, first, the utility 30 obtains the user ID and the serial number of the self-terminal as the terminal information on the self-terminal (S1802). This S1802 corresponds to S314 in FIG. 17. In S1802, the user ID and the serial number of the self-terminal held in the storage region of the self-terminal are obtained. The utility 30 then transmits the terminal information obtained in S1802 to the printer 14 (S1804). This S1804 corresponds to S1702 in FIG. 17. Note that, the printer 14 updates the printing information based on the received terminal information and also updates the update time and date information on the printing information to the time and date on which the update is performed. Additionally, if there is no received terminal information in the user information saved in the printer 14, the printer 14 adds the terminal information to the user information to update the user information and updates the update time and date information on the user information to the time and date on which the update is performed.

Next, the utility 30 obtains the printing information from the printer 14 (S1806) and saves the obtained printing information into the self-terminal to update the printing information (S1808). S1806 corresponds to S1708 and S1710 in FIG. 17, and S1808 corresponds to S1712. In S1808, the utility 30 updates the printing information and also updates the update time and date information on the printing information.

Thereafter, the utility 30 obtains the update time and date information on the user information saved in the self-terminal (S1810). Additionally, the utility 30 obtains the update time and date information on the user information from the printer 14 (S1812). This S1810 corresponds to S1714 and S1716 in FIG. 17. The utility 30 then determines whether the user information in the printer 14 is updated (S1814). This S1814 corresponds to S1718 in FIG. 17. In S1814, whether the update time and date information obtained in S1810 matches the update time and date information obtained in S1812 is determined. In S1814, if the update time and date information obtained in S1810 does not match the update time and date information obtained in S1812, it is determined that the user information is updated, and if the update time and date information obtained in S1810 matches the update time and date information obtained in S1812, it is determined that the user information is not updated.

In S1814, if it is determined that the user information in the printer 14 is not updated, the processing proceeds to S1820 described later. On the other hand, in S1814, if it is determined that the user information in the printer 14 is updated, the utility 30 obtains the user information from the printer 14 (S1816). This S1816 corresponds to S1720 and S1722 in FIG. 17. The utility 30 then saves the user information obtained in S1816 into the self-terminal to update the user information in the self-terminal (S1818). Note that, in S1818, with the updating of the user information, the update time and date information on the user information is updated to the update time and date information obtained in S1812.

Next, the utility 30 obtains the update time and date information on the ink purchase information and the notification information saved in the self-terminal (S1820). Additionally, the utility 30 obtains the update time and date information on the ink information and the notification information from the notification management server 18 (S1822). This S1822 corresponds to S1726 and S1728 in FIG. 17. The utility 30 then determines whether the ink purchase information and the notification information in the notification management server 18 are updated (S1824). This S1824 corresponds to S1730 in FIG. 17.

In S1824, for each of the ink purchase information and the notification information, whether the update time and date information obtained in S1820 matches the update time and date information obtained in S1822 is determined. In this determination, for each of the ink purchase information and the notification information, if the update time and date information obtained in S1820 does not match the update time and date information obtained in S1822, it is determined that the ink purchase information or the notification information is updated, and if the update time and date information obtained in S1820 matches the update time and date information obtained in S1822, it is determined that the ink purchase information and the notification information are not updated. Additionally, in S1824, if none of the ink purchase information and the notification information are updated, it is determined that the ink purchase information and the notification information in the notification management server 18 are not updated. On the other hand, in S1824, if at least one of the ink purchase information and the notification information is updated, it is determined that the ink purchase information and the notification information in the notification management server 18 are updated.

In S1824, if it is determined that the ink purchase information and the notification information in the notification management server 18 are not updated, the processing proceeds to S1830 described later. On the other hand, in S1824, if it is determined that the ink purchase information and the notification information in the notification management server 18 are updated, the utility 30 obtains the notification management server 18 from the updated information (S1826). This S1826 corresponds to S1732 and S1734 in FIG. 17. The utility 30 then saves the information obtained in S1826 into the self-terminal (S1828). This S1828 corresponds to S1736 in FIG. 17. In S1828, the information obtained in S1826 is saved into the self-terminal to update the information, and also the update time and date information on the information is updated to the update time and date information obtained in S1822.

Thereafter, the utility 30 performs the notification execution processing (S1830) and ends this notification processing. This S1830 corresponds to S1738 and S1740 in FIG. 17. Note that, the specific processing contents of the notification execution processing in S1830 are the same as that of the notification execution processing in S1320 in the above-described second embodiment; for this reason, the detailed descriptions thereof are omitted. Thus, in the present embodiment, the utility 30 functions as a notification unit that determines the notification contents.

### =Notification Processing in Case of No-Printing-Execution=

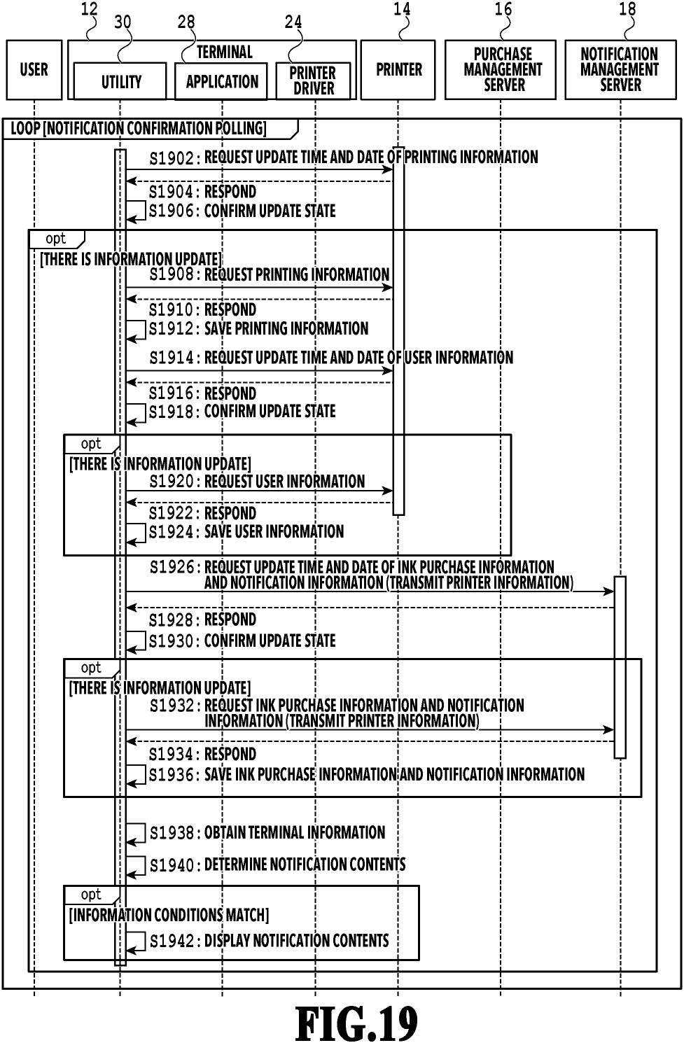

Next, the notification processing in a case of no-printing-execution in which no printing is executed is described. Also in the present embodiment, as with the second embodiment, a notification is made to the terminals 12 of the users sharing the printer 14 by the notification processing in a case of no-printing-execution. In a case of no-printing-execution, the notification processing is executed in a predetermined timing. The predetermined timing may be, for example, every predetermined time, at activation of the terminal 12, or the like. Specifically, in a case of no-printing-execution, for example, the notification processing is executed every hour. In this notification processing, the utility 30 confirms the printing state from the printer 14 and determines the notification contents and the like based on the confirmation result to make a notification. FIG. 19 is a diagram illustrating a processing sequence of the notification processing in a case of no-printing-execution in the printing system 10 in the present embodiment.

Once the notification processing in a case of no-printing-execution is started, first, the utility 30 requests the printer 14 to provide the update time and date information on the printing information (S1902) and obtains the response (S1904). The utility 30 then confirms the update state of the printing information (S1906). In S1906, the update time and date information on the printing information saved in the self-terminal is compared with the update time and date information obtained in S1904. Then, if the update time and date information on the printing information in the self-terminal and the update time and date information obtained in S1904 are different from each other, it is determined that the printing information is updated, and if the update time and date information on the printing information in the self-terminal and the update time and date information obtained in S1904 match with each other, it is determined that no printing information is updated.

If no printing information is updated, this notification processing ends. On the other hand, if the printing information is updated, the utility 30 requests the printer 14 to provide the printing information (S1908) and obtains the response (S1910). The utility 30 then saves the printing information obtained in S1910 into the self-terminal (S1912). In S1912, with the printing information obtained in S1910 being saved into the self-terminal, the printing information in the self-terminal is updated, and also the update time and date information on the printing information in the self-terminal is updated to the update time and date information obtained in S1904.

Next, the utility 30 requests the printer 14 to provide the update time and date information on the user information (S1914) and obtains the response (S1916). The utility 30 then confirms the update state of the user information (S1918). In S1918, the update time and date information on the user information saved in the self-terminal is compared with the update time and date information obtained in S1916. Then, if the update time and date information on the user information in the self-terminal and the update time and date information obtained in S1916 are different from each other, it is determined that the user information is updated, and if the update time and date information on the user information in the self-terminal and the update time and date information obtained in S1916 match with each other, it is determined that the user information is not updated.

If the user information is not updated, the processing proceeds to S1926 described later. On the other hand, if the user information is updated, the utility 30 requests the printer 14 to provide the user information (S1920) and obtains the response (S1922). The utility 30 then saves the user information obtained in S1922 into the self-terminal (S1924). In S1924, with the user information obtained in S1922 being saved into the self-terminal, the user information in the self-terminal is updated, and also the update time and date information on the user information in the self-terminal is updated to the update time and date information obtained in S1916.

Thereafter, the utility 30 requests the notification management server 18 to provide the update time and date information on the ink purchase information and the notification information (S1926) and obtains the response (S1928). The utility 30 then confirms the update state of the ink purchase information and the notification information (S1930). In S1930, the update time and date information on each of the ink purchase information and the notification information saved in the self-terminal is compared with the update time and date information on each of the ink purchase information and the notification information obtained in S1928. Then, for both the ink purchase information and notification information, if the update time and date information saved in the self-terminal matches the update time and date information obtained in S1928, it is determined that the ink purchase information and the notification information are not updated. On the other hand, for at least one of the ink purchase information and the notification information, if the update time and date information saved in the self-terminal does not match the update time and date information obtained in S1928, it is determined that the ink purchase information and the notification information are updated.

If the ink purchase information and the notification information are not updated, the processing proceeds to S1938 described later. If the ink purchase information and the notification information are updated, the utility 30 requests the notification management server 18 to provide the updated information out of the ink purchase information and the notification information (S1932) and obtains the response (S1934). The utility 30 then saves the information obtained in S1934 into the self-terminal (S1936). In S1936, with the information obtained in S1934 being saved into the self-terminal, the information in the self-terminal is updated, and also the update time and date information on the information is updated to the update time and date information obtained in S1926.

The utility 30 then obtains the user ID and the serial number of the self-terminal as the terminal information on the self-terminal (S1938). Next, the utility 30 determines the notification contents based on the terminal information on the self-terminal and the printing information, the user information, the ink purchase information, and the notification setting in the notification information saved in the self-terminal (S1940). Thereafter, the utility 30 displays the determined notification contents together with the printer information and the ink information on the ink information screen 702 displayed on the display 210 of the self-terminal to make a notification (S1942).

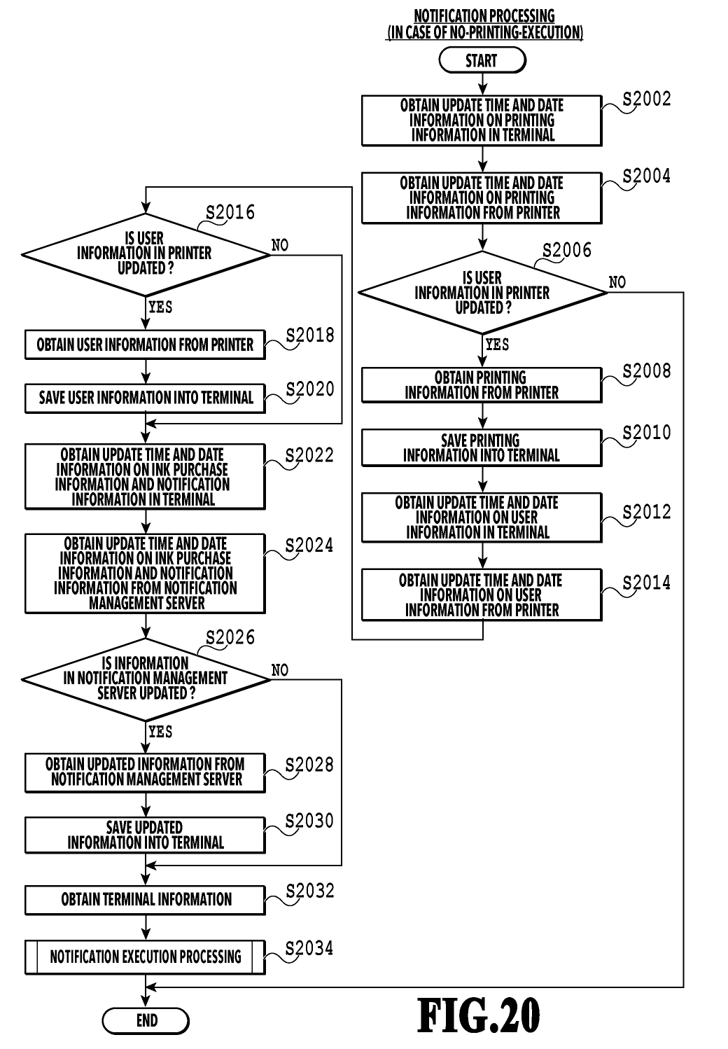

Next, the specific processing contents in the terminal 12 in the notification processing in a case of no-printing-execution are described with reference to a flowchart in FIG. 20. FIG. 20 is a flowchart illustrating a detailed processing routine of the notification processing that is executed in the terminal 12 in the notification processing in a case of no-printing-execution. A series of processing illustrated in the flowchart in FIG. 20 is performed by the CPU 202 in the terminal 12 deploying and executing the program code stored in the ROM 206 into the RAM 204. Alternatively, a part of or all the functions of the steps in FIG. 20 may be executed by hardware such as an ASIC or an electric circuit. Note that, in the descriptions of this notification processing, descriptions are given assuming that the utility 30 that is software executed by the CPU 202 in the terminal 12 executes processing in each step.

In a predetermined timing that is, for example, after the elapse of one hour from end of the notification processing of the last no-printing-execution, the terminal 12 starts the notification processing. Once this notification processing is started, first, the utility 30 obtains the update time and date information on the printing information saved in the self-terminal (S2002). Additionally, the utility 30 obtains the update time and date information on the printing information from the printer 14 (S2004). This S2004 corresponds to S1902 and S1904 in FIG. 19.

The utility 30 then determines whether the printing information in the printer 14 is updated (S2006). This S2006 corresponds to S1906 in FIG. 19. In S2006, whether the update time and date information obtained in S2002 matches the update time and date information obtained in S2004 is determined. In S2006, if the update time and date information obtained in S2002 matches the update time and date information obtained in S2004, it is determined that the printing information in the printer 14 is not updated, and if the update time and date information obtained in S2002 does not match the update time and date information obtained in S2004, it is determined that the printing information in the printer 14 is updated.

In S2006, if it is determined that the printing information in the printer 14 is not updated, this communication processing ends. On the other hand, in S2006, if it is determined that the printing information in the printer 14 is updated, the utility 30 obtains the printing information from the printer 14 (S2008) and saves the obtained printing information into the self-terminal (S2010). S2008 corresponds to S1908 and S1910 in FIG. 19, and S2010 corresponds to S1912 in FIG. 19. Thus, in the present embodiment, the utility 30 functions as an obtainment unit that obtains the ink information that is the remaining amount information on the ink. In S2010, the printing information obtained in S2008 is saved into the self-terminal to update the printing information, and also the update time and date information on the printing information is updated to the update time and date information obtained in S2004.

Next, the utility 30 obtains the update time and date information on the user information saved in the self-terminal (S2012). The utility 30 then obtains the update time and date information on the user information from the printer 14 (S2014). This S2014 corresponds to S1914 and S1916 in FIG. 19. The utility 30 then determines whether the user information in the printer 14 is updated (S2016). This S2016 corresponds to S1918 in FIG. 19. In S2016, whether the update time and date information obtained in S2012 matches the update time and date information obtained in S2014 is determined. In S2016, if the update time and date information obtained in S2012 matches the update time and date information obtained in S2014, it is determined that the user information in the printer 14 is not updated, and if the update time and date information obtained in S2012 does not match the update time and date information obtained in S2014, it is determined that the user information in the printer 14 is updated.

In S2016, if it is determined that the user information in the printer 14 is not updated, the processing proceeds to S2022 described later. On the other hand, in S2016, if it is determined that the user information in the printer 14 is updated, the utility 30 obtains the user information from the printer 14 (S2018) and saves the obtained user information into the self-terminal (S2020). S2018 corresponds to S1920 and S1922 in FIG. 19, and S2020 corresponds to S1924 in FIG. 19. Thus, in the present embodiment, the utility 30 functions as an obtainment unit that obtains the terminal information on the terminal devices sharing the printer 14. In S2020, the user information obtained in S2018 is saved into the self-terminal to update the user information, and also the update time and date information on the user information is updated to the update time and date information obtained in S2014.

Thereafter, the utility 30 obtains the update time and date information on the ink purchase information and the notification information saved in the self-terminal (S2022). Additionally, the utility 30 obtains the update time and date information on the ink purchase information and the notification information from the notification management server 18 (S2024). This S2024 corresponds to S1926 and S1928 in FIG. 19. The utility 30 then determines whether the ink purchase information and the notification information in the notification management server 18 are updated (S2026). This S2026 corresponds to S1930 in FIG. 19.

In S2026, for each of the ink purchase information and the notification information, whether the update time and date information obtained in S2022 matches the update time and date information obtained in S2024 is determined. In S2026, for both the ink purchase information and notification information, if the update time and date information obtained in S2022 matches the update time and date information obtained in S2024, it is determined that the ink purchase information and the notification information in the notification management server 18 are not updated. In S2026, for at least one of the ink purchase information and the notification information, if the update time and date information obtained in S2022 does not match the update time and date information obtained in S2024, it is determined that the ink purchase information and the notification information in the notification management server 18 are not updated.

In S2026, if it is determined that the ink purchase information and the notification information in the notification management server 18 are not updated, the processing proceeds to S2032 described later. On the other hand, in S2026, if it is determined that the ink purchase information and the notification information in the notification management server 18 are updated, the utility 30 obtains the updated information out of the ink purchase information and the notification information from the notification management server 18 (S2028). This S2028 corresponds to S1932 and S1934 in FIG. 19. Thus, in the present embodiment, the utility 30 functions as an obtainment unit that obtains the purchase authority information that is the information on whether there is the authority of ink purchase and the notification information. In S2028, the information, which indicates that the update time and date information obtained in S2022 and the update time and date information obtained in S2024 for the ink purchase information and the notification information do not match during the determination in S2026, is obtained from the notification management server 18.

The utility 30 then saves the information obtained in S2028 into the self-terminal (S2030). S2030 corresponds to S1936 in FIG. 19. In S2030, the information obtained in S2028 is saved into the self-terminal to update the information, and also the update time and date information on the information is updated to the update time and date information obtained in S2024. Thereafter, the utility 30 obtains the user ID and the serial number of the self-terminal as the terminal information on the self-terminal (S2032). This S2032 corresponds to S1938 in FIG. 19.

The utility 30 then performs the notification execution processing (S2034) and ends this notification processing. This S2034 corresponds to S1940 and S1942 in FIG. 19. Note that, the specific processing contents of the notification execution processing in S2034 are the same as that of the notification execution processing in S1320 in the above-described second embodiment; for this reason, detailed descriptions thereof are omitted. Thus, in the present embodiment, the utility 30 functions as a notification unit that determines the notification contents.

As described above, in the present embodiment, the notification contents are determined and a notification is made in the terminal 12 based on the printing information, the printer information, the ink purchase information, the notification setting, and the like. With this, it is possible to obtain the same operation and effect as that of the above-described second embodiment. Additionally, in the present embodiment, the terminal 12 obtains the printing information and the user information from the printer 14. With this, it is possible to reduce a communication load of the notification management server more than a case of the second embodiment.

### Other Embodiments

Note that, the above-described embodiments may be modified as described in (1) to (5) listed below.

(1) In the above-described embodiments, a case of applying the information processing apparatus to the printing system 10 is described as an example; however, it is possible to apply the technique according to the information processing apparatus described in the above-described embodiments to various widely-known systems. For example, it is possible to apply the technique described in the above-described embodiments to a system in which terminals of multiple users are connected through a phone line and a data communication amount caused by transmission and reception of data through the phone line between the terminals is shared.

Specifically, in the above-described system sharing the data communication amount, based on a data communication state of the terminal and the history of the terminal that purchased the data communication amount once the data communication amount reaches the upper limit, it is possible to appropriately notify each terminal of the discount information on the data communication amount by using notification setting. In this case, the above-described system includes a purchase management server, a notification management server, and the multiple terminals, for example. Note that, the multiple terminals are connected to each other through the phone line.

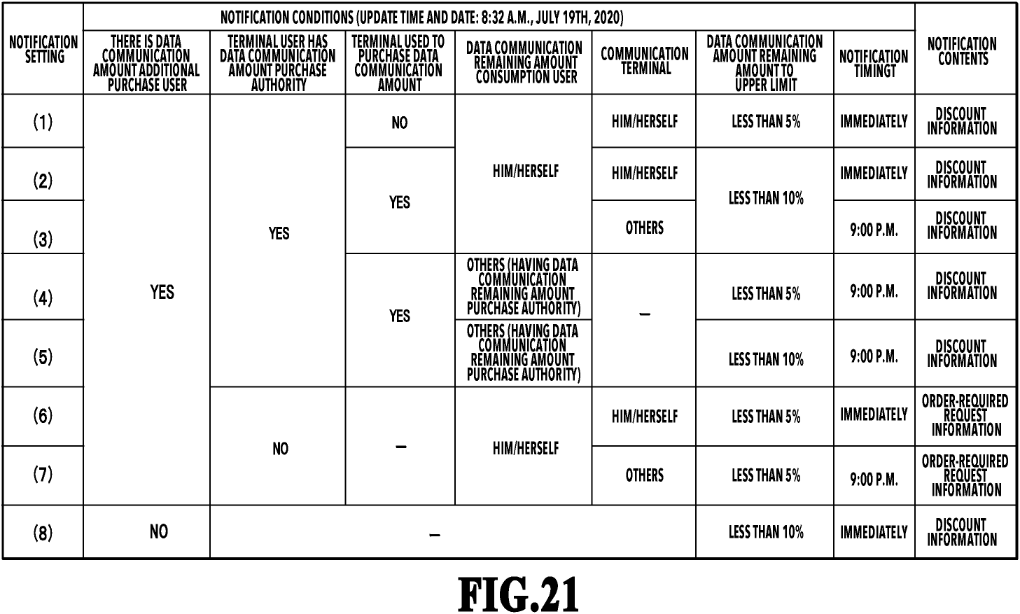

An example of the notification setting saved in a notification setting part of the notification management server is illustrated in FIG. 21. FIG. 21 is a diagram illustrating an example of the notification setting in another embodiment. In notification settings (1) and (2) in FIG. 21, in a case where the user having the purchase authority of the data communication amount consumes a data communication remaining amount, a threshold of the data communication remaining amount to notify the discount information is changed depending on whether the terminal in which the data communication by the user is performed is the terminal that is used for purchase. Additionally, in notification settings (2) and (3), the timing to make a notification to the terminal used to purchase the data communication amount is changed. With this, the terminal that is not used for purchase is not unnecessarily notified of the discount information, and it is possible to notify the terminal used for purchase of the discount information in an appropriate timing.

Moreover, “discount information” is associated with the notification contents such that the terminals of all the users having the purchase authority of the data communication amount are notified of the discount information in a case where one terminal consumes the data communication remaining amount. Note that, in notification settings (4) and (5), the threshold of the data communication remaining amount to notify the discount information is changed depending on whether the user who consumes the data communication remaining amount has the purchase authority of the data communication remaining amount. If the user has the purchase authority of the data communication amount, it is possible to confirm the discount information that is notified to the terminal of the user once the data communication remaining amount is consumed and to immediately purchase the data communication amount from the terminal if necessary. Thus, in this case, until the data communication remaining amount (to the upper limit) reaches less than 5%, the discount information is not notified to the terminal of another user having the purchase authority of the data communication amount. Additionally, in notification settings (6) and (7), in a case where the user has no purchase authority of the data communication amount (no determination is made), instead of the discount information, a notification indicating that a purchase request of the data communication amount is necessary is made. With this, it is possible to make an appropriate notification depending on whether the user has the purchase authority for data communication.

(2) In the above-described embodiments, the authority of ink purchase of the user and the terminal 12 used for ink purchase are determined based on the ink purchase information; however, it is not limited thereto. The authority of ink purchase of the user and the terminal 12 used for ink purchase may be, for example, determined based on the history of purchasing the printer 14 and the authority of a user account of the terminal.

(3) In the above-described embodiments, in the printing system 10, a configuration that allows for purchase of ink from the terminal 12 is applied, and a notification in accordance with the ink remaining amount and whether there is the ink purchase authority is made; however, it is not limited thereto. That is, in the printing system 10, a configuration that allows for purchase of a consumable other than ink such as, for example, a printing medium, a printing head, a waste ink tank, and a battery may be applied. In this case, a notification in accordance with the remaining amount of the consumable and also whether there is the purchase authority of the consumable is made to the terminal 12.

(4) In the above-described embodiments, the notification contents are the ink discount information that is information related to the discount that is applied in a case of ink purchase and the ink-purchase-required request information that is information prompting the user having the authority of ink purchase to request the purchase of ink; however, it is not limited thereto. That is, instead of the ink discount information, various types of information usable for ink purchase may be applied, or instead of the ink-purchase-required request information, various types of information prompting purchase of ink may be applied.

(5) The above-described embodiments and the various modes described in above-described (1) to (4) may be combined with each other as needed.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-012948, filed Jan. 31, 2022, which is hereby incorporated by reference wherein in its entirety.

What is claimed is:

1. An information processing apparatus configured to make a notification in each of terminal devices of users sharing a consumable, comprising:
a first obtainment unit configured to obtain terminal information that is information related to the terminal device including information related to the user;
a second obtainment unit configured to obtain remaining amount information that is information related to a remaining amount of the consumable;
a third obtainment unit configured to obtain purchase authority information that is information related to purchase authority of the consumable;
a fourth obtainment unit configured to obtain notification information including notification conditions and information related to purchase of the consumable that is set according to the notification conditions; and
a determination unit configured to determine the information related to purchase of the consumable based on the terminal information, the remaining amount information, the purchase authority information, and the notification information.

2. The information processing apparatus according to claim 1, wherein
the purchase authority information includes information related to a user having the purchase authority of the consumable and information related to the terminal device usable to purchase the consumable, and
the determination unit determines to notify the user having the purchase authority of the consumable of first information as information related to the consumable and determines to notify a user having no purchase authority of the consumable of second information, which is different from the first information, as the information related to the consumable.

3. The information processing apparatus according to claim 2, wherein
the first information is information related to discount of the consumable, and
the second information is information prompting a request to purchase the consumable.

4. The information processing apparatus according to claim 2, wherein
in a case where the remaining amount information is less than a first threshold, the determination unit determines to notify the terminal device not usable to purchase the consumable of the information related to purchase of the consumable, and
in a case where the remaining amount information is less than a second threshold, which is greater than the first threshold, the determination unit determines to notify the terminal device usable to purchase the consumable of the information related to purchase of the consumable.

5. The information processing apparatus according to claim 1, further comprising:
a fifth obtainment unit configured to obtain information related to the terminal device that executes processing to consume the consumable, wherein
the determination unit changes a timing of notification between the terminal device that executes the processing to consume the consumable and the terminal device that does not execute the processing to consume the consumable.

6. The information processing apparatus according to claim 5, wherein
the determination unit immediately makes a notification to the terminal device that executes the processing to consume the consumable and makes a notification at a predetermined time to the terminal device that does not execute the processing to consume the consumable.

7. The information processing apparatus according to claim 1, wherein the consumable is a consumable used in a printer.

8. The information processing apparatus according to claim 7, wherein the consumable is ink.

9. The information processing apparatus according to claim 1, wherein the consumable is a data communication amount consumed in the terminal device.

10. An information processing method of an information processing apparatus configured to make a notification in each of terminal devices of users sharing a consumable, comprising:
obtaining terminal information that is information related to the terminal device including information related to the user;
obtaining remaining amount information that is information related to a remaining amount of the consumable;
obtaining purchase authority information that is information related to purchase authority of the consumable;
obtaining notification information including notification conditions and information related to purchase of the consumable that is set according to the notification conditions; and
determining the information related to purchase of the consumable based on the terminal information, the remaining amount information, the purchase authority information, and the notification information.

11. A printing system, comprising:
a printer configured to perform printing on a printing medium;
a terminal device capable of displaying notified information and also executing printing by the printer; and
a server configured to manage a notification to the terminal device, wherein the server includes
a first obtainment unit configured to obtain terminal information that is information related to the terminal device including information related to a user holding the terminal device,
a second obtainment unit configured to obtain remaining amount information that is information related to a remaining amount of a consumable of the printer,
a third obtainment unit configured to obtain purchase authority information that is information related to purchase authority of the consumable,
a fourth obtainment unit configured to obtain notification information including notification conditions and information related to purchase of the consumable that is set according to the notification conditions, and
a determination unit configured to determine the information related to purchase of the consumable based on the terminal information, the remaining amount information, the purchase authority information, and the notification information.

12. The printing system according to claim 11, wherein
once processing to consume the consumable is executed, the server determines the information related to purchase of the consumable in the server, and
the terminal device notifies the information related to purchase of the consumable that is determined by the server.

13. A printing system, comprising:
a printer configured to perform printing on a printing medium;
a terminal device capable of displaying notified information and also executing printing by the printer; and
a server configured to manage a notification to the terminal device, wherein the terminal device includes
a first obtainment unit configured to obtain terminal information that is information related to the terminal device including information related to a user holding the terminal device,
a second obtainment unit configured to obtain remaining amount information that is information related to a remaining amount of a consumable of the printer,
a third obtainment unit configured to obtain purchase authority information that is information related to purchase authority of the consumable,
a fourth obtainment unit configured to obtain notification information including notification conditions and information related to purchase of the consumable that is set according to the notification conditions, and
a determination unit configured to determine the information related to purchase of the consumable based on the terminal information, the remaining amount information, the purchase authority information, and the notification information.

14. The printing system according to claim 13, wherein
in a case where processing to consume the consumable is executed, the information related to purchase of the consumable is determined in the terminal device that requests the processing and the information related to purchase of the consumable is notified, and in a case where the processing to consume the consumable is not executed, in a predetermined timing, the information related to purchase of the consumable is determined in each terminal device and the information related to purchase of the consumable is notified.

15. The printing system according to claim 14, wherein in the terminal device,
the first obtainment unit obtains the terminal information from the server,
the second obtainment unit obtains the remaining amount information from the server,
the third obtainment unit obtains the purchase authority information from the server, and
the fourth obtainment unit obtains the notification information from the server.

16. The printing system according to claim 14, wherein in the terminal device,
the first obtainment unit obtains the terminal information from the printer,
the second obtainment unit obtains the remaining amount information from the printer,
the third obtainment unit obtains the purchase authority information from the server, and
the fourth obtainment unit obtains the notification information from the server.

17. A non-transitory computer readable storage medium storing a program for causing a computer to function as an information processing apparatus, the information processing apparatus making a notification in each of terminal devices of users sharing a consumable, the information processing apparatus comprising:
a first obtainment unit configured to obtain terminal information that is information related to the terminal device including information related to the user;
a second obtainment unit configured to obtain remaining amount information that is information related to a remaining amount of the consumable;
a third obtainment unit configured to obtain purchase authority information that is information related to purchase authority of the consumable;
a fourth obtainment unit configured to obtain notification information including notification conditions and information related to purchase of the consumable that is set according to the notification conditions; and
a determination unit configured to determine the information related to purchase of the consumable based on the terminal information, the remaining amount information, the purchase authority information, and the notification information.
